(19) United States
(12) Patent Application Publication
(10) Pub. No.: US 2005/0110978 A1
(43) Pub. Date: May 26, 2005

(54) Method of authenticating articles, authenticatable polymers, and authenticatable articles

(76) Inventors: Radislav Potyrailo, Niskayuna, NY (US); Philippe Schottland, Evansville, IN (US); Marc Wisnudel, Clifton Park, NY (US); Pingfan Wu, Niskayuna, NY (US)

Correspondence Address: CANTOR COLBURN LLP, 55 GRIFFIN RD SOUTH, BLOOMFIELD, CT, 06002, US

(21) Appl. No.: 10/957,518

(22) Filed: Oct. 1, 2004

Related U.S. Application Data
(60) Provisional application No. 60/525,197, filed on Nov. 26, 2003.

(51) Int. Cl. G01J 3/44

(52) U.S. Cl. 356/71

(57) ABSTRACT

Disclosed is a method for authenticating that an article is an authenticatable article. The method uses an optical tester, the optical tester comprising an electromagnetic radiation source and a detector. The authenticatable article comprises a heat responsive compound having a temperature dependent optical interaction with the electromagnetic radiation source in the presence of a heat stimulus to produce a heat induced electromagnetic radiation signature. The method comprises placing a test portion of the article in interaction with the electromagnetic radiation source of the optical tester, creating a heated portion by exposing the test portion of the article to a heat stimulus sufficient to raise the temperature of the test portion from a temperature T1 to a temperature T2, measuring the heat induced electromagnetic radiation signature of the heated portion with the detector, and authenticating that the article is an authenticatable article if the heat induced electromagnetic radiation signature is present.

### CROSS REFERENCE TO RELATED APPLICATIONS

This application claims the benefit of U.S. provisional application Ser. No. 60/525,197 filed Nov. 26, 2003, attorney docket number 123149-1, the contents of which are incorporated herein by reference thereto.

### BACKGROUND OF INVENTION

The inventions relate to authentication technology for polymer based articles, particularly to methods of authenticating polymer based articles, methods of facilitating such authentication, and methods of making articles capable of authentication. The invention particularly relates to nondestructive authentication technology for use in data storage media or optical storage media such as compact disks (CDs) and digital versatile disks (DVDs).

Data storage media such as CDs and DVDs traditionally contain information such as machine-readable code, audio, video, text, and/or graphics. Data storage media often include one or more substrates made of polymers such as polycarbonate.

A major problem confronting the various makers and users of data storage media is the unauthorized reproduction or copying of information by unauthorized manufacturers, sellers and/or users. Such unauthorized reproduction or duplication of data storage media is often referred to as piracy and can occur in a variety of ways, including consumer level piracy at the point of end use as well as wholesale duplication of data, substrate and anti-piracy information at the commercial level. Regardless of the manner, piracy of data storage media deprives legitimate software and entertainment content providers and original electronic equipment manufacturers of significant revenue and profit.

Attempts to stop piracy at the consumer level have included the placement of electronic anti-piracy signals or features on information carrying substrates. Such electronic anti-piracy signals or features may also be referred to as copy-protection or copy-proofing. The machine readers and players of such data storage media are configured to require the identification of such anti-piracy signals prior to allowing access to the desired information. Theoretically, consumer level duplications are unable to reproduce these electronic anti-piracy signals on unauthorized copies. Unauthorized copies lacking the required electronic anti-piracy signals are unusable.

However, numerous technologies to thwart such consumer level anti-piracy technologies have been and continue to be developed. Some commercial level duplications have evolved to the point that unauthorized duplicates now contain the original electronic anti-piracy circuit, code, etc. For example, commercial level duplication methods include pit copying, radio frequency (RF) copying, “bit to bit” copying and other mirror image copying techniques which result in the placement of the anti-piracy signal on the information carrying substrate of the duplicate along with the information sought to be protected. Other technologies commonly used by hackers include the modification of the computer code in order to remove anti-piracy features and enable unlimited access to the data.

One anti-piracy technology aimed at combating these more sophisticated consumer and commercial level reproduction and copying practices involves the placement of ‘tags’ or authentication markers in substrates used in the construction of data storage media. Such tags or authentication markers can be detected at one or more points along the data storage media manufacturing or distribution chain or by the end use reader or player used to access the data on a particular CD or DVD.

For example, in Cyr et al., U.S. Pat. No. 6,099,930, tagging materials are placed in materials such as digital compact discs. A near-infrared fluorophore is incorporated into the compact disc via coating, admixing, blending or copolymerization. Fluorescence is detectable when the fluorophore is exposed to electromagnetic radiation having a wavelength ranging from 670 to 1100 nanometers.

Hubbard et al., U.S. Pat. No. 6,514,617 discloses a polymer comprising a tagging material wherein the tagging material comprises an organic fluorophore dye, an inorganic fluorophore, an organometallic fluorophore, a semi-conducting luminescent nanoparticle, or combination thereof, wherein the tagging material has a temperature stability of at least about 350 degrees C. and is present in a sufficient quantity such that the tagging material is detectable via a spectrofluorometer at an excitation wavelength from about 100 nanometers to about 1100 nanometers.

WO 00/14736 relies on one or more intrinsic physical or chemical characteristics of the substrate materials to distinguish unauthorized duplications of information-carrying substrates. Such anti-piracy characteristics may be based on performance characteristics such as (for example in the case of an optical disc) the weight and/or density of the disc; the spin rate of the disc; the acceleration and deceleration of the disc; the inertia of the disc; the spectral characteristics such as reflectance of the disc; the optical characteristics such as light transmittance of the -disc; the water absorption and dimensional stability of the disc; the data transfer rate of the disc; and the degree of wobble of the disc, or combinations of such characteristics.

Catarineu Guillen, U.S. Pat. No. 6,296,911 discloses a method for obtaining the chromatic variation of objects in response to external stimuli, the method comprising the incorporation in the desired objects of various pigments having combined effects comprising a luminescent pigment, a thermochromic pigment permitting the change in the color according to the temperature and/or a hygroscopic pigment that will provoke a variation in the chromatic characteristics according to humidity.

Lucht et al., U.S. patent application No. 2002/0149003A1 discloses a thermochromic polymer-based temperature indicator composition that comprises a polythiophene and a carrier medium. The composition is characterized in that the polythiophene is present in the medium in an amount of about 0.05 to about 5.0% by weight based on the weight of the composition. The structure of the compound is designed such that when the composition is placed in a heat exchange relationship with an article, the composition will exhibit a color change when a design temperature or a temperature beyond the design temperature is reached in the article.

However, the ability of unauthorized manufacturers, sellers, and/or users of data storage media to circumvent such practices continues to grow with increasingly sophisticated practices. For example, unauthorized manufacturers of data storage media are known to illegally obtain legitimately manufactured-tagged substrates for the purposes of making unauthorized reproductions. Moreover, the high profitability of piracy has enabled some unauthorized manufacturers and their suppliers to reverse engineer tagged substrate materials for the purpose of identifying previously unknown tags and producing similarly tagged data media storage substrate.

There is therefore a need to find methods of tagging and authenticating data storage media substrates that are currently unknown and/or unavailable to unauthorized manufacturers, sellers, and/or users of data storage media. In particular, it would be desirable to find authentication tags or markers or combinations of authentication markers for use in polymers and articles such as data storage media that are difficult to obtain, reproduce, use, and/or find. It would also be desirable to provide methods of authenticating such polymers and articles using optical testers such as data storage media players.

### BRIEF DESCRIPTION OF THE INVENTION

Disclosed herein is a method for authenticating that an article is an authenticatable article. The disclosed method uses an optical tester, the optical tester comprising an electromagnetic radiation source and a detector. The authenticatable article comprises a heat responsive compound having a temperature dependent optical interaction with the electromagnetic radiation source in the presence of a heat stimulus to produce a heat induced electromagnetic radiation signature. The method comprises placing a test portion of the article in interaction with the electromagnetic radiation source of the optical tester, creating a heated portion by exposing the test portion of the article to a heat stimulus sufficient to raise the temperature of the test portion from a temperature T1 to a temperature T2, measuring the heat induced electromagnetic radiation signature of the heated portion with the detector, and authenticating that the article is an authenticatable article if the heat induced electromagnetic radiation signature is present.

Also disclosed is an authenticatable polymer comprising a heat responsive compound having a temperature dependent optical interaction with an electromagnetic radiation source in the presence of a heat stimulus to produce a heat induced electromagnetic radiation signature, and a heat modulator that absorbs electromagnetic radiation and converts it to thermal energy.

In another embodiment, an article comprised of the disclosed authenticatable polymer is provided. In one exemplary embodiment, the disclosed article is a data storage media.

### BRIEF DESCRIPTION OF THE DRAWINGS

Referring now to the figures, which are exemplary, not limiting:

FIG. 1 represents one embodiment of a graphical illustration of the dynamic nature of the heat induced electromagnetic radiation signature as measured against intensity (y axis) versus time (x axis).

FIG. 2 represents another embodiment of a graphical illustration of the dynamic nature of the heat induced electromagnetic radiation signature as measured against intensity (y axis) versus time (x axis).

FIG. 3 represents one embodiment of a graphical illustration of the dynamic nature of the heat induced electromagnetic radiation signature as measured against intensity (y axis) versus time (x axis).

FIG. 4 is schematic representation of one embodiment of an authenticatable data storage media.

FIG. 5 is a schematic representation of another embodiment of an authenticatable data storage media.

FIG. 6 is a schematic diagram of another embodiment of an authenticatable data storage media.

FIG. 7 is a graphical illustration of the temperature increase to temperature T2 at various conditions.

FIG. 8 represents a schematic view of an experimental setup for the method of authenticating wherein fluorescence data is utilized as the test signal.

FIG. 9 is a fluorescence emission profile of samples MWB0703031-2 to -5 at an excitation wavelength of 532 nm at room temperature (cold) and when heated at about 100° C. (hot).

FIG. 10 is an illustration of the reversibility of the detection.

### DETAILED DESCRIPTION

Disclosed herein is a method of authenticating that an article is an authenticatable article. Also disclosed are authenticatable articles comprising an authenticatable polymer. The use of the authenticatable polymers disclosed herein in various polymer based articles allows for one or more parties at any point along the manufacturing chain, distribution chain, point of sale or point of use of the article to confirm or identify the presence or absence of the authenticatable polymer or article.

Authenticatable polymers and methods of authenticating provide valuable information. For example, the identification of a polymer as an authenticatable polymer or of an article as an authentictable article can provide one or more pieces of information such as the composition and source of the polymer, the source of an authenticatable article made from an authenticatable polymer, or of an article, whether a polymer or an article made therefrom is an unauthorized reproduction or duplication, the serial number (or lot number) of a polymer, the date of manufacture, and the like. In some instances, a failure to authenticate that a polymer or an article is an authenticatable polymer or authenticatable article will serve as proof of unauthorized duplication or copying.

The disclosed method uses an optical tester, the optical tester comprising an electromagnetic radiation source and a detector.

Optical testers will comprise both an electromagnetic radiation source and a detector. Optical testers may be stationary units or hand held portable devices. In one embodiment, the optical tester will be a data storage media player. Illustrative examples of data storage media include, but are not limited to, compact disks (CDs) and digital versatile disks (DVDs). In one embodiment, the optical tester will be a CD player. In another exemplary embodiment, the optical tester will be a DVD player. In another embodiment, the optical tester will be a Blu ray disc player. Illustrative examples of suitable data storage media players are those data storage media players having a read laser with a wavelength in the range of from 370 to 810 nm. In one exemplary embodiment, the optical tester will be a data storage media player comprising a read laser with a wavelength in the range of 600 to 680 nm. In another exemplary embodiment, the data storage media player will comprise a read laser with a wavelength in the range of 750 to 810 nm. In yet another exemplary embodiment, the data storage media player will comprise a read laser with a wavelength in the range of 370 to 450 nm.

Illustrative examples of electromagnetic radiation sources include visible or invisible light sources with a broad spectral distribution (e.g. lamps) or a narrow spectral distribution (light emitting diodes and lasers). In one embodiment, the electromagnetic radiation source will be a laser. In one exemplary embodiment, the electromagnetic radiation source will be a laser having a wavelength of about 750 nm to about 810 nm. In another exemplary embodiment, the electromagnetic radiation source will be a laser having a wavelength of about 600 nm to about 680 nm, while in another embodiment, the electromagnetic radiation source will be a laser having a wavelength of about 370 nm to about 450 nm.

Illustrative detectors will be capable of measuring, identifying and/or quantifying at least one of reflected electromagnetic radiation, transmitted electromagnetic radiation, emitted electromagnetic radiation, or combinations of such electromagnetic radiation as a detected signal. In one embodiment, the detector will be able to measure, quantify, and/or identify at least one of intensity, spectral distribution, ratio of intensity, peak position, or the like, as well as combinations thereof. In some exemplary embodiments the detector will be able to measure, identify and/or quantify optical interactions such as absorption, reflection, scattering, luminescence or the like as well as special properties of the detected signal such as polarization and the like. In one embodiment, the detector will be a photodetector.

Illustrative examples of the detector in one embodiment include vibrational spectrophotometers, fluorescence spectrophotometers, luminescence spectrophotometers, electronic spectrophotometers and the like and combinations thereof. Examples of vibrational spectrophotomers are Raman, infrared, Surface Enhanced Raman and Surface Enhanced Resonance Raman spectrophotomers. In one exemplary embodiment, the detector method will be at least one of fluorescence spectroscopy, luminescence spectroscopy, and the like and combinations thereof. In another exemplary embodiment, the employed detector will be a fluorescence spectrophotometer.

The heat induced electromagnetic radiation signature may be detected at a wavelength that in one embodiment is the selected wavelength(s) at which the changes from the first optical interaction to the optical interaction at temperature T2 are the greatest. In one embodiment, this detection wavelength is typically selected based on the location of a maximum emission of the heat responsive compound at either temperature T1 or T2. In one embodiment, the detection wavelength could be ±50 nm of the wavelength that results in the maximum emission, while in another embodiment the detection wavelength will be ±30 nm of the maximum emission wavelength. In one exemplary embodiment, the detection wavelength will be ±10 nm of the maximum emission wavelength.

In one embodiment, the detection wavelength used in the disclosed method to authenticate an article will be no more than or equal to about 1100 nm. In another embodiment, the detection wavelength of the authenticatable article will be no less than or equal to about 250 nm. In one exemplary embodiment, the detection wavelength used to authenticate the article will be about 350 nm to about 900 nm. In one exemplary embodiment, the detection wavelength used to authenticate the article will be about 370 nm to about 450 nm. In another exemplary embodiment one particularly exemplary embodiment, the detection wavelength used to authenticate the article will be about 600 nm to about 680 nm. In yet another exemplary embodiment, the detection wavelength will be about 750 nm to about 810 nm.

In one embodiment, the article to be authenticated will be in the shape of a formed article having thin edges and the detection of the changes in emission from exposure to a stimulus will be done at these thin edges of the article (edge emission) while the light source used for the excitation illuminates the article from the top, i.e., perpendicular to the surface of the article or at some angle to the normal to the surface (from 0 to about 80 degrees). In one exemplary embodiment, the formed article will be a data storage media device such as a CD or DVD. In another exemplary embodiment, the emission at the thin edges will be a fluorescence or luminescence emission.

Authenticatable articles or authenticatable polymers that can be authenticated or confirmed by the disclosed method will comprise a heat responsive compound having a temperature dependent optical interaction with the electromagnetic radiation source in the presence of a heat stimulus to produce a heat induced electromagnetic radiation signature. That is, the heat responsive compound will have an optical interaction with the electromagnetic radiation source at a temperature T2 that it does not have at a temperature T1 or that is significantly different from its interaction at a temperature T1. The particular interaction of the heat responsive compound with the electromagnetic radiation source at temperature T2 will produce a heat induced electromagnetic radiation signature. In one embodiment, the heat responsive compound will have a first optical interaction with the electromagnetic radiation source at a temperature T1 and a second optical interaction with the electromagnetic radiation source at a temperature T2.

Optical interaction as used herein refers to the interaction of the heat responsive compound with the electromagnetic radiation produced by the source in a manner that results in the production of a detected signal that is at least one of reflected electromagnetic radiation, transmitted electromagnetic radiation, emitted electromagnetic radiation, or combinations of such electromagnetic radiation. In one embodiment, optical interaction is at least one of absorption, reflection, scattering, or luminescence. In one exemplary embodiment, the optical interaction will be absorption. In another embodiment, the detected signal may be a luminescence emission such as photo luminescent emissions, chemiluminescent emissions, and the like. In another example, the detected signal will be a photoluminescent emission such as a fluorescence emission.

The heat induced electromagnetic radiation signature that is obtained may be a determination of the electromagnetic radiation signature at T1, the heat induced electromagnetic radiation signature at T2, a combination thereof, or a calculation based one or more of such signatures. For example, the heat induced electromagnetic radiation signature may be at least one of the intensity of a detected signal, the shape and/or location of the peak of a detected signal, the duration or decay of a detected signal over time or after removal of a heat source, the intensity ratio of a detected signal at selected wavelengths, other similar signatures and combinations of such signatures. Electromagnetic radiation signature may also refer to the entire detected signal produced by an optical interaction or to specific portions of the detected signal (e.g. specific wavelengths) or to a special property of the detected signal (e.g. polarization, . . . ). For instance, if the detected signal is the light reflected from a disk, the heat induced electromagnetic radiation signature can be the presence or absence of certain wavelengths, or the wavelength pattern of light in the reflected light. In one exemplary embodiment, the heat induced electromagnetic radiation signature will be the intensity of the detected signal.

The heat responsive compound will have a different optical interaction with the electromagnetic radiation source when heated. When the heat responsive compound is heated to a temperature T2, the optical interaction of the heat responsive compound with the electromagnetic radiation source will produce a heat induced electromagnetic radiation signature. The heat induced electromagnetic radiation signature that results from the interaction of the electromagnetic radiation source with the heat responsive compound when it is heated to a temperature T2 will always be different than the electromagnetic radiation signature that results from the interaction of the electromagnetic radiation source with the heat responsive compound at a temperature T1.

In one embodiment, the heat induced electromagnetic radiation signature of the heat responsive compound at temperature T2 will be the presence of an electromagnetic radiation signature that was previously absent when the heat responsive compound was at a temperature other than temperature T2. That is, in this embodiment, there is no electromagnetic radiation signature unless the heat responsive compound is at temperature T2.

In another embodiment, the heat induced electromagnetic radiation signature of the heat responsive compound at temperature T2 will be a change in an electromagnetic radiation signature that was previously present when the heat responsive compound was at a temperature other than that of temperature T2. In one version of this embodiment, the heat induced electromagnetic radiation signature of the heat responsive compound at temperature T2 will be a reduced or partially eliminated electromagnetic radiation signature relative to an electromagnetic radiation signature that was previously present when the heat responsive compound was at a temperature other than that of temperature T2. In another version of this embodiment, the heat induced electromagnetic radiation signature of the heat responsive compound at temperature T2 will be an increased electromagnetic radiation signature relative to an electromagnetic radiation signature that was previously present when the heat responsive compound was at a temperature other than that of temperature T2. In another embodiment, the heat responsive compound will have a first optical interaction with the electromagnetic radiation source at a temperature T1 to produce a first electromagnetic radiation signature, and a second optical interaction with the electromagnetic radiation source at a temperature T2 to produce a heat induced electromagnetic radiation signature.

In one exemplary version of this embodiment, the heat induced electromagnetic radiation signature of the heat responsive compound at temperature T2 will be the complete elimination or absence of the electromagnetic radiation signature that was previously present when the heat responsive compound was at a temperature other than that of temperature T2.

The heat induced electromagnetic radiation signature may generally be any electromagnetic energy that is produced by an optical interaction of the heat responsive compound with the electromagnetic radiation source and is capable of detection by the detector; i.e. a detected signal. In one embodiment, the heat induced radiation signature will be at least one of reflected electromagnetic radiation, transmitted electromagnetic radiation, emitted electromagnetic radiation and combinations of such heat induced electromagnetic radiation signatures. In one embodiment, the heat induced electromagnetic radiation signature that is measured by the detector is at least one of intensity, spectral distribution, ratio of intensity, peak position, and combinations thereof. In another embodiment, the heat induced electromagnetic radiation signature will be a percentage of the electromagnetic radiation emitted by the electromagnetic radiation source of the optical tester as reflected by a test portion of the article at a wavelength of the electromagnetic radiation source.

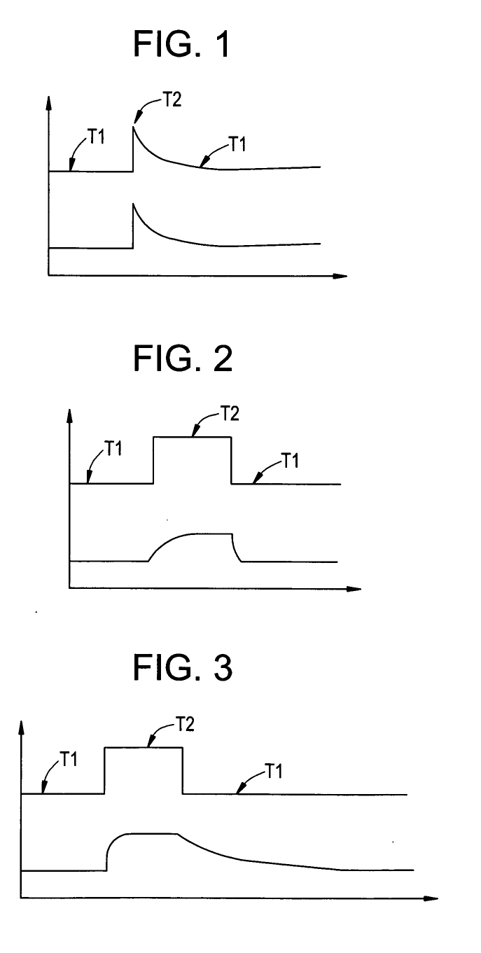

FIGS. 1-3 graphically illustrate the dynamic nature of the heat induced electromagnetic radiation signature. Each Figure shows a graphical representation of a different heat induced electromagnetic radiation signature as measured against intensity (y axis) versus time (x axis). The upper or top curve in each Figure shows a local temperature profile of the test portion of the article to be authenticated when heated to a temperature T2. The lower or bottom curve in each Figure illustrates a photodetector signal, i.e., the measured heated induced electromagnetic radiation signature.

In FIG. 1, the heat induced electromagnetic radiation signature is identical to the local temperature profile of the heated test portion. That is, as the heat is lost from the test portion, and the heat responsive compound cools down and is no longer at temperature T2, the intensity of the heat induced electromagnetic radiation signature is immediately proportionately reduced.

In FIG. 2, the intensity of the heat induced electromagnetic radiation signature gradually increases over time as the test portion of the article to be authenticated is maintained at a temperature T2. The heat induced electromagnetic radiation signature is removed or eliminated shortly after the temperature of the test portion is returned to a temperature T1.

In FIG. 3, the heat induced electromagnetic radiation signature is almost immediately produced when the test portion is heated to a temperature T2. However, in this embodiment, the heat induced electromagnetic radiation signature is not immediately removed or eliminated when the temperature of the test portion is returned to a temperature T1. Rather, in this embodiment, the intensity of the heat induced electromagnetic radiation signature is only gradually reduced over time, even though the test portion of the article to be authenticated is returned to a temperature T1.

It will be appreciated that the individual dynamic natures of various heat responsive compounds may be used as a particularly unique authentication signature. The difficulty of predicting the particularly selected signature of a particular heat responsive compound is advantageous in providing an authentication method that thwarts unauthorized duplication and copying activities. In one embodiment, different signatures may be selected for different customers or production batches, even though the same heat responsive compound may be used in all cases. For example, a manufacturer of polycarbonate could produce a single type of polycarbonate that could be used by several different data storage media manufacturers but which would still provide each manufacturer with a “unique” method of authentication.

An article may be authenticated as an authenticatable article if the heat induced electromagnetic radiation signature of the article is substantially the same as the heat induced electromagnetic radiation signature of the authenticatable article. In one embodiment, this will mean that the signature for both the test article and the authenticatable article will have a relative difference in value of less than or equal to about 5%. In other embodiments, variations between the signatures of the test article and the authenticatable article of up to ±20% can be tolerated, while in other embodiments, variations of less than about ±10% will be found.

It is an aspect of the disclosed method that a test portion of the article to be authenticated be placed in interaction with the electromagnetic radiation source of the optical tester. The test portion of the article may be the entire article or may be only a portion of the article. In one exemplary embodiment, the test portion of the article to be authenticated will be a portion of the article containing a localized concentration of the heat responsive compound as discussed below. Thus, it is an advantage of the disclosed method that only a portion of the article to be authenticated need be heated to the temperature T2. The size of the test portion can be as small as the spot created by a laser, i.e. about 1 micron, to about the size of an entire article. In one embodiment, the test portion will be about 0.1 cm to about 20 cm in diameter. In another embodiment, the test portion will be about 0.5 cm to about 15 cm in diameter.

The disclosed method also requires that the test portion of the article to be authenticated be exposed to a heat stimulus sufficient to raise the temperature of the test portion from a temperature T1 to a temperature T2. The test portion having a temperature T2 may be referred to as the heated portion.

In one embodiment, T1 is a temperature of about 5 to about 55 degrees C., while in another embodiment; T1 is a temperature of about 5 to about 35 degrees C.

In one embodiment, T2 is a temperature of about 35 to about 235 degrees C., while in another embodiment; T2 is a temperature of about 45 to about 150 degrees C.

In another exemplary embodiment, the temperature difference between T2 and T1 ranges from about 5 to about 200 degrees C. In another embodiment, the temperature difference between T2 and T1 ranges from about 5 to about 100 degrees C. In one exemplary embodiment, T1 is a temperature of about 10 to about 40 degrees C. and T2 is a temperature of about 45 to about 145 degrees C.

The creation of the heated portion of the article to be authenticated may be done via the exposure of the test portion to a heat stimulus. The heat stimulus may be a direct heat stimulus or an indirect heat stimulus with respect to the article to be authenticated. The heat stimulus may be internal or external relative to the optical tester.

In one embodiment, the heat stimulus may be a direct heat stimulus such as a source of heat that transfers thermal energy to the test portion via direct contact or via a heated fluid such as air or liquid. A direct heating source may be a hand device or stand-alone heating apparatus or heat generated by the operation of the optical tester itself. Other illustrative examples of suitable direct heating apparatus include heat guns, ovens, hot plates, heater bands, heat radiating sources and the like.

An indirect stimulus does not transfer thermal energy to the heated portion of the test portion to be heated via direct contact or via a heated fluid such as air or liquid. Rather, an indirect stimulus transfers non-thermal energy to a portion of the test portion where the non-thermal energy is converted to thermal energy. The stimulus can be either internal (e.g. laser beam from an optical tester) or external (e.g. infrared heating lamp).

For example, in one embodiment, the indirect stimulus will be electromagnetic radiation from the electromagnetic radiation source. In one embodiment, the electromagnetic radiation may be infrared radiation that heats the test portion of the article to be authenticated from a temperature T1 to a temperature T2.

In another embodiment, the electromagnetic radiation serving as an indirect heat stimulus will be absorbed by a heat modulating compound that converts electromagnetic energy into thermal energy. The presence of such a heat modulating compound in or on the article to be authenticated results in an internal heat buildup sufficient to raise the temperature of the test portion to temperature T2. As a result, the heat responsive compound has a temperature dependent optical interaction with the incoming electromagnetic radiation and produces the heat induced elcetromagnetic radiation signature. Thus, in one exemplary embodiment, the heat stimulus originates from the interaction of the heat modulating compound and the electromagnetic radiation source.

Examples of suitable heat modulating compounds that absorb electromagnetic radiation and convert it to thermal energy include near infrared (NIR) absorbers, UV absorbers, inorganic nanoparticles such as described below, polymers or colorants absorbing at least a portion of the electromagnetic radiation, combinations of such heat modulating compounds, and the like.

In one exemplary embodiment, a NIR (near infrared) absorber and more specifically its absorption characteristics can be used to create an internal heat pulse induced by the electromagnetic radiation source containing NIR radiation. One commercially available example of such an NIR absorber is Uvinul NIR 7788 (also referred to as Lumogen IR-788), commercially available from BASF, Germany. In one embodiment, a laser with a wavelength of about 780 nm will be directed at an article comprising a heat modulating compound comprising NIR 7788. The NIR 7788 will partially absorb the laser and transform the absorbed energy into heat thus raising the temperature of the test portion to temperature T2. Other examples of suitable NIR absorbers include phthalocyanine derivatives (such as Pro-Jet 830 from Avecia, Manchester, United Kingdom); Nickel, Copper, Platinum, Palladium and other organometallic complexes, (“Keysorb” NIR dyes series, available from Keystone Aniline Corporation, Chicago, Ill.); anthraquinones derivatives (Epolin 9000 series available from Epolin Inc., Newark, N.J.) and in particular tetra-substituted anthraquinones; arylquinone methides such as naphthoquinone or benzoquinone methides; indamines and indamine derivatives; indonapthol derivatives; Squarylium and croconium dyes; organic salts such as those from oxazine, thiazine and other azine derivatives; and the like. Inorganic nanoparticles with NIR absorption characteristics include but are not limited to titanium dioxide (TiO₂), tin oxide (SnO₂), indium tin oxide (ITO), tin oxide and ITO derivatives containing additional doping agents such as antimony, and lanthanum salts such as lanthanum hexafluoroborate (LaBF₆). In one embodiment, the average particle size of the inorganic nanoparticles will range between about 1 nm and about 50 nm. In a preferred embodiment, the particle size distribution (measured by laser light scattering method or by electronic microscopy) will be such that a minimum of 90% of the particles has a size below or equal to about 50 nm. In a more preferred embodiment, all nanoparticles will have a size below or equal to about 50 nm.

The duration of the time to which a test portion is subjected to a heat source sufficient to raise the temperature to temperature T2 will vary depending on the size of the test portion to be heated, the size and configuration of the article, the composition of any substrate polymers, the nature and concentration of the heat responsive compound, the nature and strength of the heat stimulus, the method used to create the heated portion, the presence of additives that will increase heat conductivity in the substrate (such as alumina, metallic fillers, and the like). In one embodiment, the test portion will be subjected to a heat stimulus for a time of no less than or equal to about 500 nanoseconds. In another embodiment, the test portion will be subjected to a heat stimulus for a time of no more than or equal to about 600 s (10 minutes). In one embodiment, the test portion will be subjected to a heat source for a time of about 1 millisecond to 300 s. In one exemplary embodiment, the test portion will be subjected to a heat stimulus for a time of about 10 milliseconds to 150 s.

In one exemplary embodiment of the invention, the article to be authenticated will be a data storage media and the optical tester will be a data storage media player. Although the maximum temperature increase in the test portion is not strongly related to the spinning speed of the data storage media, the speed at which the data storage media spins will affect the duration of time required to maintain temperature T2. In one embodiment, the spinning speed of the data storage media should be slow enough to give the heat responsive compound enough time at temperature T2 to produce the temperature dependent optical interaction that results in the heat induced electromagnetic radiation signature. In one exemplary embodiment the data storage media will be spinning during the method of authentication at a rate R between 1 rpm and 40,000 rpm while in another embodiment, the data storage media will be spinning at a rate R between 100 rpm and 10,000 rpm. In another version of this embodiment, the heat induced electromagnetic radiation signature will be measured when the data storage media is spinning at a test spinning rate R2 that is different from the normal spinning rate R1 of the data storage media. In one embodiment, the rate R1 will be smaller than the rate R2 while in another embodiment, normal spinning rate R1 will be greater than the test spinning rate R2.

In one embodiment, the heating of the test portion creates a heated portion having a change in at least one of the following material properties consisting of electronic absorption, refractive index, birefringence, dimensional stability, luminescence, and combinations thereof.

It will be appreciated that the article to be authenticated may be exposed to the heat stimulus before, during or after exposure to the electromagnetic radiation source as well as a combination thereof. In one exemplary embodiment, the article to be authenticated will be exposed to the heat stimulus while it is being exposed to the electromagnetic radiation source.

In one embodiment of the disclosed method, the method may further comprise measuring the heat induced electromagnetic radiation signature originating from the interaction of the electromagnetic radiation source with the test portion at temperature T1 followed by measuring the heat induced electromagnetic radiation signature originating from the interaction of the electromagnetic radiation source with the test portion at temperature T2.

The article to be authenticated will comprise a heat responsive compound. In one embodiment, the heat responsive compound may be a temperature-sensitive inorganic material, a temperature-sensitive organic material, or a combination of such heat responsive compounds. In another embodiment, the heat responsive compound is a temperature-sensitive inorganic material that is at least one of phosphor, semiconductor quantum dots, anti-stokes shift luminescent compounds, stokes shift luminescent compounds, inorganic salts, and combinations of such temperature-sensitive inorganic materials. In yet another embodiment, the heat responsive compound may be at least one of a temperature dependent phase separable polymer, a polymer having a coefficient of thermal expansion greater than about 0.1 mm per ° C., and combinations of such heat responsive compounds. In one exemplary embodiment, the heat responsive compound is at least one compound selected from the group consisting of thermochromic compounds, temperature sensitive scattering compounds, compounds having a temperature sensitive refractive index change, compounds having a temperature sensitive dimensional stability, temperature sensitive photo luminescent compounds, temperature sensitive encapsulated dyes, leuco dyes protected with a thermally labile group and combinations thereof. In another exemplary embodiment, the heat responsive compound may be a temperature-sensitive organic material that is at least one of an organic absorbing dye, an organic fluorescent dye, a liquid crystal material, a thermochromic compound, an organic salt, a leuco dye protected with a thermally labile group, and combinations of such temperature-sensitive organic materials.

Several of the above noted heat responsive compounds may be described as fluorescent tags. Fluorescent tags as used herein refers to at least one of an organic fluorophore, an inorganic fluorophore, an organometallic fluorophore, a luminescent nanoparticle, or combinations thereof. In addition, in one exemplary embodiment the fluorescent tags used are insensitive to polymer additives and to chemical and physical aging of the polymer.

In one exemplary embodiment, the fluorescent tags used as heat responsive compounds are selected from classes of dyes that exhibit high robustness against ambient environmental conditions and temperature stability of at least about 350° C., preferably at least about 375° C., and more preferably at least about 400° C. Typically, the fluorescent tags have temperature stability for a time period greater than or equal to about 10 minutes and preferably, greater than or equal to about 1 minute, and more preferably, greater than or equal to about 20 seconds.

The excitation range of suitable fluorescent tags used as heat responsive compounds is typically about 100 nanometers to about 1100 nanometers, and more typically about 200 nanometers to about 1000 nanometers, and most typically about 250 nanometers to about 950 nanometers. The emission range of suitable fluorescent tags used as heat responsive compounds is typically about 250 nanometers to about 2500 nanometers.

In one embodiment, the maximum excitation wavelength of the fluorescent tags will be no more than or equal to about 800 nm. In another embodiment, the maximum excitation wavelength of the fluorescent tag will be no less than or equal to about 250 nm. In one exemplary embodiment, the maximum excitation wavelength of the fluorescent tag will be about 350 nm to about 700 nm. In one exemplary embodiment, the maximum excitation wavelength of the fluorescent tag will be about 450 nm to about 650 nm. In one particularly exemplary embodiment, the maximum excitation wavelength of the fluorescent tag used as the heat responsive compound will be about 500 nm to about 600 nm.

Illustrative heat responsive compounds include fluorescent tags such as the following but are not limited to, dyes such as perylene derivatives, polyazaindacenes or coumarins, including those set forth in U.S. Pat. No. 5,573,909. Other suitable families of dyes include lanthanide complexes, hydrocarbon and substituted hydrocarbon dyes; polycyclic aromatic hydrocarbons; scintillation dyes (preferably oxazoles and oxadiazoles); aryl- and heteroaryl-substituted polyolefins (C2-C8 olefin portion); carbocyanine dyes; phthalocyanine dyes and pigments; oxazine dyes; carbostyryl dyes; porphyrin dyes; acridine dyes; anthraquinone dyes; anthrapyridone dyes; naphtalimide dyes; benzimidazole derivatives; arylmethane dyes; azo dyes; diazonium dyes; nitro dyes; quinone imine dyes; tetrazolium dyes; thiazole dyes; perinone dyes, bis-benzoxazolylthiophene (BBOT), and xanthene and thioxanthene dyes, indigoid and thioindigoid dyes.

Fluorescent tags useful as heat responsive compounds also include anti-stokes shift dyes that absorb in the near infrared wavelength and emit in the visible wavelength.

The following is a partial list of commercially available, suitable fluorescent and/or luminescent dyes useful as the fluorescent tag: 5-amino-9-diethyliminobenzo(a)phenoxazonium perchlorate 7-amino-4-methylcarbostyryl, 7-amino-4-methylcoumarin, 7-amino-4-trifluoromethylcoumarin, 3-(2′-benzimidazolyl)-7-N,N-diethylamninocoumarin, 3-(2′-benzothiazolyl)-7-diethylaminocoumarin, 2-(4-biphenylyl)-5-(4-t-butylphenyl)-1,3,4-oxadiazole, 2-(4-biphenylyl)-5-phenyl-1,3,4-oxadiazole, 2-(4-biphenyl)-6-phenylbenzoxazole-1,3,2,5-bis-(4-biphenylyl)-1,3,4-oxadiazole, 2,5-bis-(4-biphenylyl)-oxazole, 4,4′-bis-(2-butyloctyloxy)-p-quaterphenyl, p-bis(o-methylstyryl)-benzene, 5,9-diaminobenzo(a)phenoxazonium perchlorate, 4-dicyanomethylene-2-methyl-6-(p-dimethylaminostyryl)-4H-pyran, 1,1′-diethyl-2,2′-carbocyanine iodide, 1,1′-diethyl-4,4′-carbocyanine iodide, 3,3′-diethyl-4,4′,5,5′-dibenzothiatricarbocyanine iodide, 1,1′-diethyl-4,4′-dicarbocyanine iodide, 1,1′-diethyl-2,2′-dicarbocyanine iodide, 3,3′-diethyl-9,11-neopentylenethiatricarbocyanine iodide, 1,3′-diethyl-4,2′-quinolyloxacarbocyanine iodide, 1,3′-diethyl-4,2′-quinolylthiacarbocyanine iodide, 3-diethylamino-7-diethyliminophenoxazonium perchlorate, 7-diethylamino-4-methylcoumarin, 7-diethylamino-4-trifluoromethylcoumarin, 7-diethylaminocoumarin, 3,3′-diethyloxadicarbocyanine iodide, 3,3′-diethylthiacarbocyanine iodide, 3,3′-diethylthiadicarbocyanine iodide, 3,3′-diethylthiatricarbocyanine iodide, 4,6-dimethyl-7-ethylaminocoumarin, 2,2′-dimethyl-p-quaterphenyl, 2,2-dimethyl-p-terphenyl, 7-dimethylamino-1-methyl-4-methoxy-8-azaquinolone-2,7-dimethylamino-4-methylquinolone-2,7-dimethylamino-4-trifluoromethylcoumarin, 2-(4-(4-dimethylaminophenyl)-1,3-butadienyl)-3-ethylbenzothiazolium perchlorate, 2-(6-(p-dimethylaminophenyl)-2,4-neopentylene-1,3,5-hexatrienyl)-3-methylbe nzothiazolium perchlorate, 2-(4-(p-dimethylaminophenyl)-1,3-butadienyl)-1,3,3-trimethyl-3H-indolium perchlorate, 3,3′-dimethyloxatricarbocyanine iodide, 2,5-diphenylfuran, 2,5-diphenyloxazole, 4,4′-diphenylstilbene, 1-ethyl-4-(4-(p-dimethylaminophenyl)-1,3-butadienyl)-pyridinium perchlorate, 1-ethyl-2-(4-(p-dimethylaminophenyl)-1,3-butadienyl)-pyridinium perchlorate, 1-ethyl-4-(4-(p-dimethylaminophenyl)-1,3-butadienyl)-quinolium perchlorate, 3-ethylamino-7-ethylimino-2,8-dimethylphenoxazin-5-ium perchlorate, 9-ethylamino-5-ethylamino-10-methyl-5H-benzo(a)phenoxazonium perchlorate, 7-ethylamino-6-methyl-4-trifluoromethylcoumarin, 7-ethylamino-4-trifluoromethylcoumarin, 1,1′,3,3,3′,3′-hexamethyl-4,4′,5,5′-dibenzo-2,2′-indotricarboccyanine iodide, 1,1′,3,3,3′,3′-hexamethylindodicarbocyanine iodide, 1,1′,3,3,3′,3′-hexamethylindotricarbocyanine iodide, 2-methyl-5-t-butyl-p-quaterphenyl, N-methyl-4-trifluoromethylpiperidino-<3,2-g>coumarin, 3-(2′-N-methylbenzimidazolyl)-7-N,N-diethylaminocoumarin, 2-(1-naphthyl)-5-phenyloxazole, 2,2′-p-phenylen-bis(5-phenyloxazole), 3,5,3′″″,5″″-tetra-t-butyl-p-sexiphenyl, 3,5,3″″,5″″-tetra-t-butyl-p-quinquephenyl, 2,3,5,6-1H,4H-tetrahydro-9-acetylquinolizino-<9,9a,1-gh>coumarin, 2,3,5,6-1H,4H-tetrahydro-9-carboethoxyquinolizino-<9,9a, 1-gh>coumarin, 2,3,5,6-1H,4H-tetrahydro-8-methylquinolizino-<9,9a, 1-gh>coumarin, 2,3,5,6-1H,4H-tetrahydro-9-(3-pyridyl)-quinolizino-<9,9a, 1-gh>coumarin, 2,3,5,6-1H,4H-tetrahydro-8-trifluoromethylquinolizino-<9,9a, 1-gh>coumarin, 2,3,5,6-1H,4H-tetrahydroquinolizino-<9,9a, 1-gh>coumarin, 3,3′,2″,3′″-tetramethyl-p-quaterphenyl, 2,5,2″″,5′″-tetramethyl-p-quinquephenyl, p-terphenyl, p-quaterphenyl, nile red, rhodamine 700, oxazine 750, rhodamine 800, IR 125, IR 144, IR 140, IR 132, IR 26, IR5, diphenylhexatriene, diphenylbutadiene, tetraphenylbutadiene, naphthalene, anthracene, 9,10-diphenylanthracene, pyrene, chrysene, rubrene, coronene, phenanthrene.

Fluorescent tags as used herein also include semi-conducting luminescent nanoparticles of sizes from about 1 nanometer to about 50 nanometers. Exemplary luminescent nanoparticles include, but are not limited to, CdS, ZnS, Cd₃ P₂, PbS, or combinations thereof. Luminescent nanoparticles also include phosphors rare earth aluminates including, but not limited to, strontium aluminates doped with Europium and Dysprosium. Other luminescent nanoparticles include photoluminescent compounds based on Lanthanide (III).

In one embodiment, fluorescent tags such as perylene derivatives such as anthra[2,1,9-def:6,5,10-d′e′f′]diisoquinoline-1,3,8,10(2H,9H)-tetrone and/or 2,9-bis[2,6-bis(1-methyethyl)phenyl]-5,6,12,13-tetraphenoxy are utilized as the heat responsive compounds.

In one exemplary embodiment, the fluorescent tags will be at least one of fluorescent perylene derivatives such as Lumogen Red-F-300 and Orange F-240 (BASF, Germany); fluorescent anthrapyridones such as Solvent Red 149; coumarin derivatives such as Macrolex Fluorescent Red G (Bayer, Germany); thioxanthene dyes such as Marigold Orange (DayGlo) and Solvent Orange 63 (Farbtex, China); thioindigoid derivatives such as Pigment Red 181 (Farbtex, China), Vat Violet 3 (DayGlo), and Vat Red 41 (Farbtex, China) as well as combinations of such fluorescent tags.

The concentration of the heat responsive compounds if used in an authenticatable polymer depends on the quantum efficiency of the heat responsive compound, excitation and emission wavelengths, and employed detection techniques, and will generally be present in an amount of about 10-18 percent by weight to about 2 percent by weight of the authentication polymer. In another embodiment the heat responsive compound will be present in an amount of about 10-15 percent by weight to. about 0.5 percent by weight of the authentication polymer. In one exemplary embodiment, the fluorescent tag used as a heat responsive compound will be present in an amount of about 10⁻¹² percent by weight to about 0.05 percent by weight of the authentication polymer.

The term ‘thermochromic compounds’ generally refers to compounds that change color as a function of temperature. However, ‘thermochromic compounds’ as used herein refers to compounds that have a first optical interaction with the electromagnetic radiation source at a first temperature, and a second optical interaction with the electromagnetic radiation source at an authenticating temperature wherein the authenticating temperature is greater than the first temperature and the first and second optical interactions are different. The first optical interaction can produce a first signal and the second optical interaction a second signal. The first temperature is sometimes referred to as the ‘cold’ state and the authenticating temperature as the ‘hot’ state. ‘Authenticating temperature’ as used herein refers to any temperature at or above the thermochromic transition of the thermochromic compound. In one exemplary embodiment, the authenticating temperature will be the temperature T2. In one exemplary embodiment, the second signal is the heat induced electromagnetic radiation signature. Note that in some cases, it may be desirable to perform the authentication by analyzing the signal produced after heating (‘hot’ state) and then upon cooling (‘cold’ state).

In one exemplary embodiment the first and second signals of the thermochromic compound will be different by at least about 5%, based on the fluorescence intensity or ratio of fluorescence intensity of the thermochromic compound. In another embodiment, the first and second signals of the thermochromic compound will be different by at least about 10 nm, based on the fluorescence peak location of the thermochromic compound.

Suitable thermochromic compounds for use in the disclosed methods will generally be organic materials that are selected to be chemically compatible with any substrate polymer that the heat responsive compound is located in or on. Suitable thermochromic compounds will also have heat stability consistent with engineering plastics compounding and in particular with the processing conditions of any polymer substrate utilized. In one embodiment, the stable thermochromic compounds will be conjugated polymers containing aromatic and/or heteroatomic units exhibiting thermochromic properties.

Illustrative examples of thermochromic compounds suitable for use as the heat responsive compound include poly(3-alkylthiophene)s, poly(3,4-alkylenedioxythiophene)s, poly(3,4-alkylenedioxypyrroles), alkyl/aryl substituted poly(isothianaphtenes)s and corresponding copolymers, blends or combinations of the corresponding monomers.

In one embodiment, the polythiophene is generally of the structure: 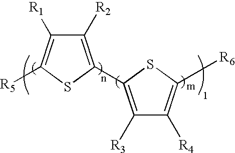
wherein R₁—R₆ is a hydrogen, substituted or unsubstituted alkyl radical, substituted or unsubstituted alkoxy radical, substituted or unsubstituted aryl radical, substituted or unsubstituted thioalkyl radical, substituted or unsubstituted trialkylsilyl radical, substituted or unsubstituted acyl radical, substituted or unsubstituted ester radical, substituted or unsubstituted amine radical, substituted or unsubstituted amide radical, substituted or unsubstituted heteroaryl or substituted or unsubstituted aryl radical, n is between 1 and 1000, m is between 0 and 1000, and l is between 1 and 1000. In another embodiment, R₁—R₂ or R₃—R₄ comprise a 5 or 6 membered ring. In another embodiment, R₁—R₂ or R₃—R₄ comprise a ring with 6 or more members. In yet another embodiment, R₂—R₃ are bridged forming a ring with 6 or more members.

In synthesizing a polythiophene for a specific design temperature, e.g. for the series of poly(3-alkylthiophene)s there is roughly an inverse correlation with the length of the n-alkane substituent and the temperature of the thermochromic transition for both the regiorandom (R₁=alkyl, R₄=alkyl, n≅0.8, m≅0.2, l=40-80, R₂, R₃, R₅, R₆═H) and regioregular (R₁=alkyl, n=40-80, m=0, R₂, R₅, R₆═H), poly(3-n-alkylthiophene)s. For regiorandom polymers, longer substituents such as n-hexadecyl have lower temperature thermochromic transitions (81° C.) than shorter chain substituents such as n-octyl (130° C.). The regioregular polymers have higher thermochromic transitions than the regiorandom polymers but the same inverse correlation with chain length is observed. The n-hexadecyl and n-octyl have thermochromic transition from about 125 to about 175° C. As long as the number of thiophene units in the polymer is approximately greater than sixteen the thermochromic transition is molecular weight independent. Oligothiophenes (n+m+l<16) have lower temperature thermochromic transitions than the polythiophenes (n+m+l>16).

In one exemplary embodiment, the thermochromic compound used as a heat responsive compound will be a regiorandom polymer. In one exemplary embodiment, the thermochromic compound will be a regiorandom polymer in the poly(3-alkylthiophene) series. In another exemplary embodiment, the thermochromic compound will be an oligothiophene wherein (n+m+l<16).

In one embodiment, the thermochromic compound utilized as a heat responsive compound will be a thermochromic compound having a thermochromic transition temperature of no less than or equal to about −30° C. In one embodiment, the thermochromic compound utilized will be a thermochromic compound having a thermochromic transition temperature of no more than or equal to about 250° C. In another embodiment, the thermochromic compound utilized will be a thermochromic compound having a thermochromic transition temperature of about 35 to about 195° C. In another exemplary embodiment, the thermochromic compound utilized will be a thermochromic compound having a thermochromic transition temperature of about 45 to about 135° C.

The thermochromic compound used as a heat responsive compound may be used in an amount sufficient to be detected by the detector. In one embodiment, the thermochromic compound will be present in an authenticatable polymer as discussed below in an amount of no more than or equal to about 10.0% by weight, based on the weight of the authenticatable polymer. In another embodiment, the thermochromic compound will be present in the authenticatable polymer in an amount of less than or equal to about 5.0% by weight, based on the weight of the authenticatable polymer. In one exemplary embodiment, the thermochromic compound will be present in the authenticatable polymer in an amount of less than or equal to about 1.0% by weight, based on the weight of the authenticatable polymer. In yet another exemplary embodiment, the thermochromic compound will be present in the authenticatable polymer in an amount of less than or equal to about 0.05% by weight, based on the weight of the authenticatable polymer. In one embodiment, the thermochromic compound will be present in the authenticatable polymer in an amount of at least 0.005% by weight, based on the weight of the authenticatable polymer.

In one exemplary embodiment, the thermochromic compound will be present in or on the article in an amount of about 0.001% to about 10.0% by weight, based on the weight of the article. In another exemplary embodiment, the thermochromic compounds will be present in an amount of about 0.01% to about 5.0% by weight, based on the weight of the article, while in another, the thermochromic compounds will be present in an amount of about 0.02% to about 1.0% by weight, based on the weight of the article. In one particularly exemplary embodiment, the thermochromic compounds will be present in an amount of about 0.03% to 1.0% by weight, based on the weight of an authenticatable polymer used in the article.

In one exemplary embodiment, the thermochromic compound is present in an amount of less than 0.50% by weight, based on the weight of an authenticatable polymer used in the article. In another exemplary embodiment, the thermochromic compound is present in an amount of about 0.005 to about 0.50% by weight, based on the weight of an authenticatable polymer used in the article. In another exemplary embodiment, the thermochromic compound is present in an amount of about 0.02 to less than 0.50% by weight, based on the weight of the authenticatable polymer used in the article.

In one exemplary embodiment the substrate polymer will be transparent and the thermochromic compound will be used in an amount of from 0.005 to about 0.1% by weight, based on the weight of the authenticatable polymer. Such lower concentrations of thermochromic compounds are advantageous because the resulting authenticatable polymers exhibit a more rapid switch from the ‘cold’ state to the ‘hot’ state.

In one exemplary embodiment, the thermochromic compound will be present in the authenticatable polymer in an amount that does not provide a visually retrievable thermochromic response. That is, the amount of the thermochromic compound in the authenticatable polymer or on the article does not result in a color change apparent to the unaided human eye when the article or the authenticatable polymer is exposed to temperature at or above the thermochromic transition temperature, i.e., at temperature T2.

In one embodiment, the heat responsive compound may be a temperature sensitive scattering compound such as an inorganic salt. In this embodiment, a spot of salt in a matrix is located on a surface of an article in the optical path of an electromagnetic radiation source such as a laser. In a first state (cold), the spot of salt scatters the laser light (i.e. the amount of light hitting the detector is low). When the spot of salt reaches temperature T2, the melting of the salt is triggered. As a result, the laser beam is no longer scattered and the light intensity sensed by a detector is high.

In another embodiment, electromagnetic radiation goes through a surface of a data storage media comprising a polycarbonate substrate to a spot made of a material with poor dimensional stability (like high thermal expansion coefficient) placed thereon. Local heating by either an internal or external heat source will cause pit deformation and/or defocusing errors affecting readout of data under the spot. As a result, the detector will sense a change in the light intensity of the beam.

Both the heat responsive compound and the optional heat modulating compound may be located in or on the article to be authenticated. If the heat modulating compound is present, it is not necessary for both the heat responsive compound and the heat modulating compound to be located together or in the same place. In one exemplary embodiment, the heat responsive compound and the heat modulating compound will not be present in the same portion of the article or polymer to be authenticated. In another exemplary embodiment, the heat responsive compound and the heat modulating compound will be present in the same portion of the article or polymer to be authenticated.

In one embodiment, either of the heat responsive compound or the heat modulating compound may be in at least a portion of the article to be authenticated. In one embodiment, one or both of the heat responsive compounds and the heat modulating compound may be distributed throughout a portion of the article, while in another embodiment, one or both of the heat responsive compound and the heat modulating compound will be contained in a localized area of at least a portion of the article. In one exemplary embodiment, one or both of the heat responsive compound and the heat modulating compound will be distributed homogeneously throughout a portion of the article.

Similarly, one or both of the heat responsive compound and the heat modulating compound may be on at least a portion of a surface of the article to be authenticated or may be applied to an entire surface. In one embodiment, one or both of the heat responsive compound and the heat modulating compound may be distributed evenly on a surface of the article, while in another embodiment, one or both of the heat responsive compound and the heat modulating compound will be contained in a localized area on the surface of at least a portion of the article.

In one exemplary embodiment, at least one portion or component of the article to be authenticated or the authenticatable article will comprise an authenticatable polymer comprising a substrate polymer, a heat responsive compound as described above, and optionally, a heat modulator as described above. In one exemplary embodiment, the authenticatable polymer will comprise a substrate polymer, a heat responsive compound, and a heat modulator.

Some possible examples of suitable polymers which can be utilized as the substrate polymer include, but are not limited to, amorphous, crystalline and semi-crystalline thermoplastic materials: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones; polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, polytetrafluoroethylenes, as well as thermosetting resins such as epoxy, phenolic, alkyds, polyester, polyimide, polyurethane, mineral filled silicone, bis-maleimides, cyanate esters, vinyl, and benzocyclobutene resins, in addition to blends, copolymers, mixtures, reaction products and composites comprising the foregoing plastics.

As used herein, the terms “polycarbonate”, “polycarbonatecomposition”, and “composition comprising aromatic carbonate chain units” include compositions having structural units of the formula (I): 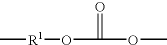
in which at least about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (II):
   -A₁-Y₁-A₂-
wherein each of A₁ and A₂ is a monocyclic divalent aryl radical and Y₁ is a bridging radical having one or two atoms which separate A₁ from A₂. In an exemplary embodiment, one atom separates A₁ from A₂. Illustrative, non-limiting examples of radicals of this type are —O—, —S—, —S(O)—, —S(O₂)—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, and adamantylidene. The bridging radical Y₁ can be a hydrocarbon group or a saturated hydrocarbon group such as methylene, cyclohexylidene or isopropylidene.

Polycarbonates can be produced by the interfacial reaction of dihydroxy compounds in which only one atom separates A₁ and A₂. As used herein, the term “dihydroxy compound” includes, for example, bisphenol compounds having general formula (III) as follows: 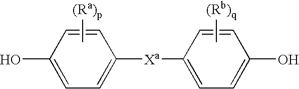
wherein R^{a} and R^{b} each represent a halogen atom or a monovalent hydrocarbon group and may be the same or different; p and q are each independently integers from 0 to 4; and X^{a} represents one of the groups of formula (IV):

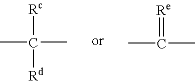

wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include dihydric phenols and the dihydroxy-substituted aromatic hydrocarbons disclosed by name or formula (generic or specific) in U.S. Pat. No. 4,217,438. A nonexclusive list of specific examples of the types of bisphenol compounds that may be represented by formula (III) includes the following: 1,1-bis(4-hydroxyphenyl)methane; 1,1-bis(4-hydroxyphenyl)ethane; 2,2-bis(4-hydroxyphenyl)propane (hereinafter “bisphenol A” or “BPA”); 2,2-bis(4-hydroxyphenyl)butane; 2,2-bis(4-hydroxyphenyl)octane; 1,1-bis(4-hydroxyphenyl)propane; 1,1-bis(4-hydroxyphenyl)n-butane; bis(4-hydroxyphenyl)phenylmethane; 2,2-bis(4-hydroxy-1-methylphenyl)propane; 1,1-bis(4-hydroxy-t-butylphenyl)propane; bis(hydroxyaryl)alkanes such as 2,2-bis(4-hydroxy-3-bromophenyl)propane; 1,1-bis(4-hydroxyphenyl)cyclopentane; and bis(hydroxyaryl)cycloalkanes such as 1,1-bis(4-hydroxyphenyl)cyclohexane; and the like as well as combinations comprising the foregoing.

It is also possible to employ two or more different dihydric phenols or a copolymer of a dihydric phenol with a glycol or with a hydroxy- or acid-terminated polyester or with a dibasic acid or with a hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates may be prepared by adding a branching agent during polymerization.

These branching agents are well known and may comprise polyfunctional organic compounds containing at least three functional groups which may be hydroxyl, carboxyl, carboxylic anhydride, haloformyl and mixtures comprising the foregoing. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha,alpha-dimethyl benzyl)phenol), 4-chloroformyl phthalic anhydride, trimesic acid and benzophenone tetracarboxylic acid, and the like. The branching agents may be added at a level of about 0.05 to about 2.0 weight percent. Branching agents and procedures for making branched polycarbonates are described in U.S. Pat. Nos. 3,635,895 and 4,001,184. All types of polycarbonate end groups are herein contemplated.

In one embodiment, the substrate polymer will be a polycarbonate based on bisphenol A, in which each of A₁ and A₂ is p-phenylene and Y₁ is isopropylidene. In one embodiment, the average molecular weight of the polycarbonate is about 5,000 to about 100,000. In another exemplary embodiment, the average molecular weight of a polycarbonate used as the substrate polymer will be about 10,000 to about 65,000, while in another exemplary embodiment, a polycarbonate used as the polymer will have an average molecular weight of about 15,000 to about 35,000.

In monitoring and evaluating polycarbonate synthesis, it is of particular interest to determine the concentration of Fries product present in the polycarbonate. As noted, the generation of significant Fries product can lead to polymer branching, resulting in uncontrollable melt behavior. As used herein, the terms “Fries” and “Fries product” denote a repeating unit in polycarbonate having the formula (V): 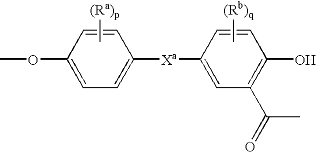
wherein X^{a} is a bivalent radical as described in connection with formula (III) described above.

Polycarbonate compositions suitable for use as the substrate polymer may also include various additives ordinarily incorporated in resin compositions of this type. Such additives are, for example, fillers or reinforcing agents; heat stabilizers; antioxidants; light stabilizers; plasticizers; antistatic agents; mold releasing agents; additional resins; blowing agents; and the like, as well as combinations comprising the foregoing additives. Combinations of any of the foregoing additives may be used. Such additives may be mixed at a suitable time during the mixing of the components for forming the composition.

Examples of fillers or reinforcing agents include glass fibers, asbestos, carbon fibers, silica, talc and calcium carbonate.

Examples of heat stabilizers include triphenyl phosphite, tris-(2,6-dimethylphenyl)phosphite, tris-(mixed mono- and di-nonylphenyl)phosphite, dimethylbenene phosphonate and trimethyl phosphate.

Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Other possible antioxidants include, for example, organophosphites, e.g., tris(nonyl-phenyl)phosphite, tris(2,4-di-t-butylphenyl)phosphite, bis(2,4-di-t-butylphenyl)pentaerythritol diphosphite, distearyl pentaerythritol diphosphite and the like; alkylated monophenols, polyphenols and alkylated reaction products of polyphenols with dienes, such as, for example, tetrakis[methylene(3,5-di-tert-butyl-4-hydroxyhydrocinnamate)]methane, 3,5-di-tert-butyl-4-hydroxyhydrocinnamate octadecyl, 2,4-di-tert-butylphenyl phosphite, and the like; butylated reaction products of para-cresol and dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds, such as, for example, distearylthiopropionate, dilaurylthiopropionate, ditridecylthiodipropionate, and the like; amides of beta-(3,5-di-tert-butyl-4-hydroxyphenyl)-propionic acid; and the like, as well as combinations of the foregoing.

Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone.

Examples of plasticizers include dioctyl-4,5-epoxy-hexahydrophthalate, tris-(octoxycarbonylethyl)isocyanurate, tristearin and epoxidized soybean oil.

Examples of antistatic agents include glycerol monostearate, sodium stearyl sulfonate, and sodium dodecylbenzenesulfonate.

Examples of mold releasing agents include stearyl stearate, beeswax, montan wax and paraffin wax.

Examples of other resins include but are not limited to polypropylene, polystyrene, polymethyl methacrylate, and polyphenylene oxide.

Other additives ordinarily incorporated in resin compositions of this type may also be used. Such additives may include antioxidants, heat stabilizers, anti-static agents (tetra alkylammonium benzene sulfonate salts, tetra alkylphosphonium benzene sulfonate salts, and the like), mold releasing agents (pentaerythritol tetrastearate; glycerol monstearate, and the like), and the like, and combinations comprising any of the foregoing. Other potential additives which may be employed comprise; UV absorbers; stabilizers such as light and thermal stabilizers (e.g., acidic phosphorous-based compounds); hindered phenols; zinc oxide, zinc sulfide particles, or combination thereof; lubricants (mineral oil, and the like), plasticizers, dyes used as a coloring material (anthraquinones, anthrapyridones, methane dyes, quinophthalones, azo dyes, perinones, and the like); among others, as well as combinations of the foregoing additives.

For example, in one exemplary embodiment the authenticatable polymer composition can comprise heat stabilizer from about 0.01 weight percent to about 0.1 weight percent; an antistatic agent from about 0.01 weight percent to about 1 weight percent; and a mold releasing agent from about 0.1 weight percent to about 1 weight percent of a mold releasing agent; based upon the weight of the authenticatable polymer.

In order to aid in the processing of the authenticatable polymer, particularly when the substrate polymer is polycarbonate, catalyst(s) may also be employed, namely in the extruder or other mixing device. The catalyst typically assists in controlling the viscosity of the resulting material. Possible catalysts include hydroxides, such as tetraalkylammonium hydroxide, tetraalkylphosphonium hydroxide, and the like, with diethyldimethylammonium hydroxide and tetrabutylphosphonium hydroxide preferred. The catalyst(s) can be employed alone or in combination with quenchers such as acids, such as phosphoric acid, and the like. Additionally, water may be injected into the polymer melt during compounding and removed as water vapor through a vent to remove residual volatile compounds.

The authenticatable polymers disclosed herein are produced by using a reaction vessel capable of adequately mixing various precursors, such as a single or twin screw extruder, kneader, blender, or the like.

Methods for incorporating the heat responsive compounds and optionally the heat modulating compounds, into the substrate polymer include, for example, solution casting, admixing, blending, or copolymerization. In one embodiment, the heat responsive compounds and the heat modulating compounds can be incorporated into or onto the substrate polymer such that they are uniformly dispersed throughout the authenticatable polymer or such that they are dispersed on a portion of the authenticatable polymer. In one exemplary embodiment, the heat responsive compounds and the heat modulating compounds will be incorporated into the substrate polymer such that they are uniformly dispersed throughout the authenticatable polymer. The heat responsive compounds and the heat modulating compounds can be incorporated into the polymer in the polymer manufacturing stage, during the polymer compounding step, during polymer processing into articles, or combinations thereof. It is possible to incorporate both the heat responsive compounds and the heat modulating compounds simultaneously or separately. In one embodiment, one or more heat responsive compounds and the heat modulating compounds will be introduced using a concentrate (i.e. masterbatch) either during the polymer compounding stage or during the article forming process.

For example, the polymer precursors for the substrate polymer can be premixed with the heat responsive compounds and the heat modulating compounds (e.g., in a pellet, powder, and/or liquid form) and simultaneously fed using a gravimetric or volumetric feeder into the extruder, or the heat responsive compounds and the heat modulating compounds can be optionally added in the feed throat or through an alternate injection port of the injection molding machine or other molding apparatus. Optionally, in one embodiment, a substrate polymer can be produced and the heat responsive compounds and the heat modulating compounds can be dispersed on a portion of a substrate polymer by coating, molding, or welding on a portion of an authenticatable polymer. In one exemplary embodiment, the heat responsive compounds and the heat modulating compounds will be homogenously distributed unless they were placed in a carrier that is not miscible with the substrate polymer.

In one embodiment, the heat responsive compounds will be incorporated into the substrate polymer by admixing, blending, compounding or copolymerization. In one exemplary embodiment, the heat responsive compounds will be incorporated into the polymer by forming a dry blend of the heat responsive compounds in the polymer and compounding the resulting mixture.

The heat modulating compounds may also be incorporated into the substrate polymer by admixing, blending, compounding or copolymerization. In one exemplary embodiment, the heat modulating compounds will be incorporated into the substrate polymer by adding the heat responsive compounds in the melt during the compounding step. Any of such additions may, in one embodiment, be done via a side feeder.

In another embodiment, both the heat responsive compounds and the heat modulating compounds may be incorporated into the substrate polymer by adding the heat responsive compounds and the heat modulating compounds in the melt during compounding. In one exemplary embodiment, the heat responsive compounds and the heat modulating compounds will be incorporated by compounding using a twin-screw extruder and adding the heat responsive compounds and the heat modulating compounds to the melt via a side feeder. In another exemplary embodiment, the heat modulating compound and the heat responsive compound will be incorporated into the substrate polymer by compounding using a twin-screw extruder wherein the heat responsive compound will be added downstream of the extruder via a side feeder.

When the substrate polymer precursors are employed, the extruder should be maintained at a sufficiently high temperature to melt the polymer precursors without causing decomposition thereof. For polycarbonate, for example, temperatures of about 220° C. to about 360° C. can be used in one embodiment. In another embodiment, temperatures of about 260° C. to about 320° C. are utilized. Similarly, the residence time in the extruder should be controlled to minimize decomposition. Residence times of up to about 10 minutes can be employed, with up to about 5 minutes used in one embodiment, up to about 2 minutes used in another embodiment, and up to about 1 minute used in yet another embodiment. Prior to extrusion into the desired form (typically pellets, sheet, web, or the like), the resulting mixture can optionally be filtered, such as by melt filtering and/or the use of a screen pack, or the like, to remove undesirable contaminants or decomposition products.

The authenticatable polymers may be used for any application in which the physical and chemical properties of the material are desired. In one embodiment, the authenticatable polymers will be used to make articles to be authenticated. In one embodiment, the article comprising the authenticatable polymers will be data storage media. Other articles comprising the authenticatable polymers include packaging material (and especially drug packaging), automotive parts like lenses, telecom accessories (like cell phone covers), computers and consumer electronics, construction materials, medical devices, eyeware products, films and sheets (including those used in display applications) and the like.

The method of authenticating disclosed herein may authenticate an article. In general, the goal of the method of authentication will be to determine whether a test article is or is not an authenticatable article or whether a test article comprises an authenticatable polymer. In one exemplary embodiment, the article will be a polymer composition to be authenticated. In one embodiment, the test article will comprise polycarbonate. In another embodiment, the article to be authenticated will be a data storage media. In one exemplary embodiment, the article to be authenticated will be a data storage media comprising at least one component or portion comprising polycarbonate. In one exemplary embodiment, the article to be authenticated will be a DVD or a CD.

The disclosed method of authentication may be used more than once or only once. The repeatability of the authentication step for any article or authenticatable article depends on whether the heat responsive compound recovers after the initial production of the heat induced electromagnetic radiation signature at temperature T2 and is capable of undergoing the desired optical interaction at temperature T2 more than once.

Data storage media, which can be authenticated using the disclosed authentication method, can be formed using various molding techniques, processing techniques, or combinations thereof. Suitable molding techniques include injection molding, film casting, extrusion, press molding, blow molding, stamping, and the like. One possible process comprises an injection molding-compression technique where a mold is filled with a molten polymer that in one embodiment may be the authenticatable polymer. The mold may contain a preform, inserts, fillers, etc. The polymer is cooled and, while still in an at least partially molten state, compressed to imprint the desired surface features (e.g., pits, grooves, edge features, smoothness, and the like), arranged in spiral concentric or other orientation, onto the desired portion(s) of the formed part, i.e. one or both sides in the desired areas. The formed part is then cooled to room temperature. Once the formed part has been produced, additional processing, such as electroplating, coating techniques (spin coating, spray coating, vapor deposition, screen printing, painting, dipping, and the like), lamination, sputtering, and combinations comprising the foregoing processing techniques, among others known in the art, may be employed to dispose desired layers on the substrate.

An example of a data storage media comprises an injection molded substrate that may optionally comprise a hollow (bubbles, cavity, and the like) or filled (metal, plastics, glass, ceramic, and the like, in various forms such as fibers, spheres, particles, and the like) core. In one embodiment, the molded substrate may comprise polycarbonate.

In one embodiment when a formed authenticatable article or test article is a data storage media, the authenticatable polymer will preferably be used to form the substrate(s) that will be read through by a laser in a data storage media player device as it is significantly more difficult to fake the response of an authenticatable polymer and to ensure that the employed technology does not impact playability of the media. In a data storage media having two substrates, such as a DVD, one or both substrates can be formed using the authenticatable polymers. In one exemplary embodiment, the substrate of a DVD formed of the authenticatable polymer will be the substrate read through by a laser in a DVD player device.

Disposed on a substrate of the data storage media are various layers including: a data layer, dielectric layer(s), a semi reflective layer, a bonding layer, a reflective layer(s), and/or a protective layer, as well as combinations comprising the foregoing layers.

In one embodiment, the authenticatable article or the article to be authenticated will be a data storage media comprising a read through substrate layer and a reflective layer. In another embodiment, the article will further comprise one or more additional substrate layer. In yet another embodiment, the article will further comprise a bonding layer. In yet another embodiment, the article further comprising one or more additional substrate layers may also comprise a semi-reflective layer.

These layers comprise various materials and are disposed in accordance with the type of media produced. For example, for a first surface media, the layers may be as follows: protective layer, dielectric layer, data storage layer, dielectric layer, and then a reflective layer disposed in contact with the substrate, with an optional decorative layer disposed on the opposite side of the substrate. Meanwhile, for one type of optical media, the layers may be optional decorative layer, protective layer, reflective layer, dielectric layer, and data storage layer, with a subsequent dielectric layer in contact with the substrate. Optical media may include, but are not limited to, any conventional pre-recorded, re-writable, or recordable formats such as: CD, CD-ROM, CD-R, CD-RW, DVD, DVD-R, DVD-RW, DVD-RAM, DVD-ROM, high-density DVD, enhanced video disk (EVD), super audio CD (SACD), magneto-optical, Blu Ray, and others. It is understood that the form of the media is not limited to disk-shape, but may be any shape which can be accommodated in a readout device.

The data storage layer(s) may comprise any material capable of storing retrievable data, such as an optical layer, magnetic layer, or a magneto-optic layer. Possible data storage layers include, but are not limited to, oxides (such as silicone oxide), rare earth elements--transition metal alloys, nickel, cobalt, chromium, tantalum, platinum, terbium, gadolinium, iron, boron, others, alloys, organic dyes (e.g., cyanine or phthalocyanine type dyes), inorganic phase change compounds (e.g., TeSeSn, InAgSb, and the like) and combinations comprising the foregoing.

The protective layer(s) protect against dust, oils, and other contaminants. The thickness of the protective layer(s) is usually determined, at least in part, by the type of read/write mechanism employed, e.g., magnetic, optic, or magneto-optic. Possible protective layers include anti-corrosive materials such as gold, silver, nitrides (e.g., silicon nitrides and aluminum nitrides, among others), carbides (e.g., silicon carbide and others), oxides (e.g., silicon dioxide and others), polymeric materials (e.g., polyacrylates or polycarbonates), carbon film (diamond, diamond-like carbon, and the like), among others, and combinations comprising the foregoing.

The dielectric layer(s) may be disposed on one or both sides of the data storage layer and are often employed as heat controllers. Possible dielectric layers include nitrides (e.g., silicon nitride, aluminum nitride, and others); oxides (e.g., aluminum oxide); carbides (e.g., silicon carbide); and combinations comprising of the foregoing materials, among other materials compatible within the environment and preferably not reactive with the surrounding layers.

The reflective layer(s) should have a sufficient thickness to reflect a sufficient amount of energy (e.g., light) to enable data retrieval. Possible reflective layers include any material capable of reflecting the particular energy field, including metals (e.g., aluminum, silver, gold, titanium, silicon, and alloys and mixtures comprising the foregoing metals, and others).

In addition to the data storage layer(s), dielectric layer(s), protective layer(s) and reflective layer(s), other layers can be employed such as lubrication layer and others. Useful lubricants include fluoro compounds, especially fluoro oils and greases, and the like.

In one embodiment, the authenticatable polymers will be formed into the substrate of a data storage media. In one exemplary embodiment, the authenticatable polymer will comprise the substrate of an optical storage media.

In one particularly exemplary embodiment, the authenticatable polymer will comprise at least one substrate of a digital versatile disk (DVD). Illustrative DVDs comprising the authenticatable polymers disclosed herein comprise two bonded plastic substrates (or resin layers), each typically having a thickness less than or equal to about 0.8 millimeter (mm), with a thickness of less than or equal to about 0.7 mm preferred. A thickness of greater than or equal to about 0.5 mm is also preferred. At least one of the two bonded plastic substrates comprises one or more layers of data. The first layer, generally called layer zero (or L0), is closest to the side of the disk from which the data is read (readout surface). The second layer, generally called layer 1 (L1), is further from the readout surface. Disposed between L0 (3) and L1 (5) are typically an adhesive and optionally a protective coating or separating layer. Single sided DVD's (i.e., those that will be read from a single readout surface disposed on one side of the DVD), can additionally comprise a label disposed on the side of the DVD opposite the readout surface. In one embodiment, one or both of the first layer and the second layer will be comprised of the authenticatable polymers. In one exemplary embodiment, the first layer will be comprised of the authenticatable polymer.

In the case of a single layer read from a readout surface (e.g. DVD 5, DVD 10), a stamped surface is covered with a thin reflective data layer by a sputtering or other deposition process. This creates a metallic coating typically about 60 to about 100 angstroms (Å) thick. For two data layer DVDs that are read from the same readout surface (e.g. DVD 9, DVD 14, DVD 18), the laser must be able to reflect from the first layer when reading it, but also focus (or transmit) through the first layer when reading the second layer. Therefore, the first layer is “semi-transparent” (i.e., semi-reflective), while the second layer is “fully-reflective”. Under current standards set by the Consortium for Optical Media, metallization combination for the fully-reflective and semi-reflective data layers, as measured per the electrical parameter R14H (as described in ECMA specifications #267), should be about 18 percent (%) to about 30% at the wavelength of the laser. In the present DVD's, the laser wavelength generally employed is less than or equal to about 700 nm, with about 370 nm to about 680 nm preferred, and about 600 nm to about 680 nm more preferred. Although these metallization standards were set for DVD data layers employed with colorless, optical quality resin, they are equally applied to DVD systems with colored resin.

When color is added to the resin, light transmission through and reflected from the substrate is effected. The metallization nature and thickness on the semi-reflective and fully reflective (L0 and L1) layers is adapted for the light transmission of the substrate. Desired reflectivity can be obtained by balancing the metallization thickness with the reflectivity of the semi-reflective data layer, and by adjusting the thickness of the fully reflective data layer to ensure its reflectivity is within the desired specification.

Metallization for the individual data layer(s) can be obtained using various reflective materials. Materials, e.g., metals, alloys, and the like, having sufficient reflectivity to be employed as the semi-reflective and/or fully reflective data layers, and which can preferably be sputtered onto the substrate, can be employed. Some possible reflective materials comprise gold, silver, platinum, silicon, aluminum, and the like, as well as alloys and combinations comprising at least one of the foregoing materials. For example, the first/second reflective data layer metallization can be gold/aluminum, silver alloy/aluminum, silver alloy/silver alloy, or the like.

In addition to the overall reflectivity of each layer, the difference in reflectivity between subsequent reflective data layers should be controlled, in order to ensure sufficient reflectivity of the subsequent layer. Preferably, the difference in reflectivity between subsequent layers (e.g., the first and second layers) is less than or equal to about 5%, with less than or equal to about 4% preferred, and less than or equal to about 3.0% more preferred. It is further preferred to have a reflectivity difference between the adjacent reflective data layers of greater than or equal to about 0.5%, with greater than or equal to about 1% more preferred. It should be noted that although described in relation to two layers, it is understood that more than two layers could be employed, and that the difference in reflectivity between subsequent layers should be as set forth above.

The reflective data layers are typically sputtered or otherwise disposed on a pattern (e.g., surface features such as pits, grooves, asperities, start/stop orientator, and/or the like) formed into a surface of the substrate via molding, embossing, or the like. Depositions, for example, can comprise sputtering a semi-reflective data layer over a first patterned surface. A separator layer or protective coating can then be disposed over the semi-reflective data layer. If a multiple data layer DVD (e.g., DVD 14, DVD 18, or the like) is to be formed, a 2nd patterned surface can be formed (e.g., stamped or the like) in the side of the separator layer opposite the semi-reflective data layer. A fully reflective data layer can then be sputtered or otherwise deposited on the separator layer. Alternatively, for DVD 14 construction, the fully reflective data layer can be deposited on a patterned surface of a 2nd substrate (or resin layer). A separate layer or protective coating is then disposed on one or both of the semi-reflective data layer and the fully reflective data layer. A bonding agent or adhesive can then be disposed between the two substrates and they can be bonded together to form a disk. Optionally, several semi-reflective data layers can be deposited with a separator layer between each subsequent layer.

The reflectivity of the reflective data layer(s) can be about 5% to about 100%, depending upon the number of reflective layers. If a single reflective data layer is employed, the reflectivity is preferably about 30% to about 100%, with about 35% to about 90% more preferred, and about 45% to about 85% even more preferred. If a dual reflective data layer is employed, the reflectivity of the data layers is preferably about 5% to about 45%, with about 10% to about 40% more preferred, about 15% to about 35% even more preferred, and about 18% to about 30% especially preferred. Finally, if multiple reflective data layers (e.g., greater than 2 reflective data layers readable from a single reading surface) are employed, the reflectivity is preferably about 5% to about 30%, with about 5% to about 25% more preferred. The especially preferred ranges are currently based upon the ECMA specification #267, wherein the reflectivity is either about 18% to about 30% reflectivity for a dual layered DVD (e.g., at least one fully reflective layer and at least one semi-reflective layer) or about 45% to about 85% reflectivity for a single layer DVD (e.g., one fully reflective layer).

In one embodiment, the polymers used to make these DVD substrates will enable the transmission of about 60% to less than 94% of light therethrough, in the wavelength region of the laser. Within that transmission range, preferably, the transmissivity is greater than or equal to about 70%, with greater than or equal to about 74% more preferred, and greater than or equal to about 78% especially preferred. Depending upon the type and amount of colorant employed, the transmissivity can be less than or equal to about 92%, with less than or equal to about 88% and even less than or equal to about 85% possible, depending upon the type of colorant. It should be noted that as the transmissivity of the substrate decreases, the ability to attain the desired adhesion of the substrates becomes more difficult. Preferably, the substrate comprises polycarbonate, with a primarily polycarbonate (e.g., greater than or equal to about 80% polycarbonate) substrate especially preferred.

As previously discussed, the heat responsive compounds and optionally, the heat modulating compounds may be in or on the article to be authenticated or the authenticatable article. In one embodiment when the article or authenticatable article is a data storage media disk, the data storage media will comprise a read through substrate layer and a reflective layer. In another version of this exemplary embodiment, the data storage media will further comprise one or more additional substrate layers. In yet another version of this exemplary embodiment, the data storage media will further comprise a bonding layer. In yet another version of this exemplary embodiment, the article further comprising one or more additional substrate layers may also comprise a semi-reflective layer.

In one embodiment, the heat modulator may be on a surface of the read through substrate layer. In another version, the heat modulator may be in the read through substrate layer.

In one embodiment, the heat responsive compound may be located on a surface of the read through substrate layer of the data storage media. In another embodiment, the heat responsive compound is in the read through substrate layer of the data storage media. In one version of these embodiments, the read through substrate layer is comprised of polycarbonate. In one exemplary embodiment, the read through substrate layer will be comprised of the authenticatable polymer. In another embodiment, the heat responsive compound is in the bonding layer.

In another embodiment, both the heat responsive compound and the heat modulator are in the bonding layer. In yet another embodiment, the heat responsive compound and the heat modulator are in the read through substrate layer. In one exemplary embodiment, the heat responsive compound and the heat modulator compound are in the read through substrate layer.

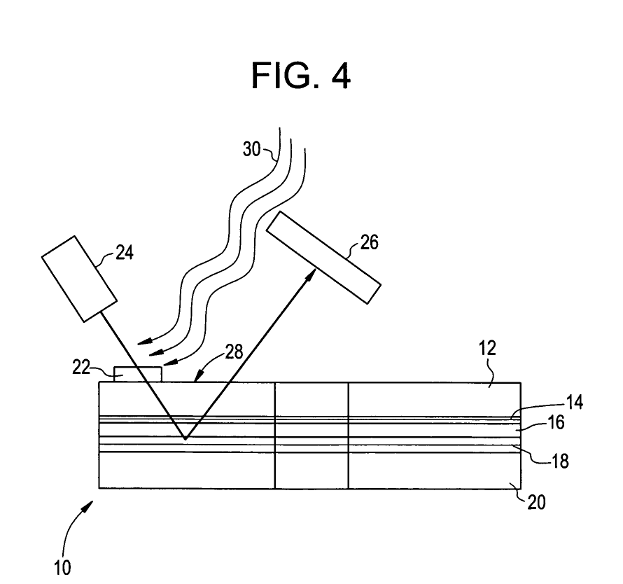

Turning now to the data storage media 10 in the embodiment of FIG. 4, the heat modulating compound will be present in the read through substrate 12, the heat responsive compound will be present as a localized test portion 22 on an uppermost surface 28 of the read through substrate 12. The data storage media 10 also comprises semi-reflective layer 14, bonding layer 16, reflective layer 18, and a second substrate layer 20. Read through substrate 12 may also contain the heat modulating compound if the electromagnetic radiation source 24 is indirect. Detector 26 captures and measures the heat induced electromagnetic radiation signature produced when the heat responsive material in localized test portion 22 reaches temperature T2. If the heat modulating compound is not present in the read through substrate 12, an external heat source 30 may be used to raise the temperature of the test portion 22. In one exemplary embodiment, the read through substrate 12 will be comprised of the authenticatable polymer wherein the substrate polymer comprises polycarbonate.

Alternatively, FIG. 4 can be used to illustrate another embodiment wherein the localized spot 22 is comprised of the heat modulating compound and the heat responsive compound is present in the read through substrate 12.

Finally, FIG. 4 can also be used to illustrate yet another embodiment. In this case, the localized spot 22 is comprised of the heat modulating compound. However, in this embodiment, the heat responsive compound may be present in the bonding layer 16.

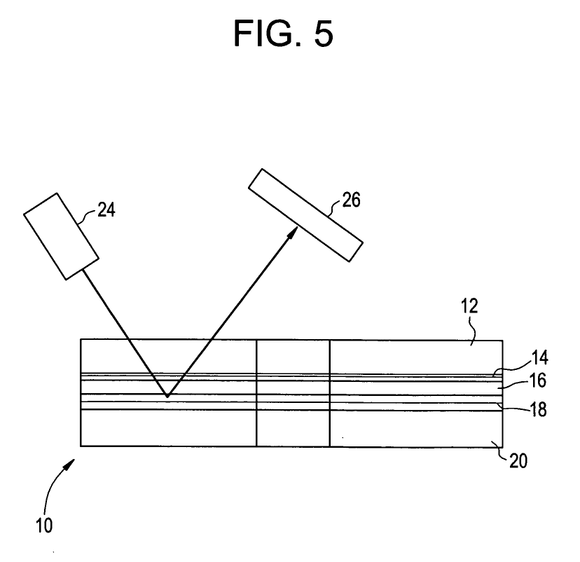

Turning to the embodiment of FIG. 5, in this case, the data storage media 10 comprises the heat modulating compound in read through substrate layer 12, while the heat responsive material is present in the bonding layer 16.

In an alternative embodiment of the data storage media 10 of FIG. 5, the read through substrate layer 12 comprises the heat responsive compound while the heat modulating compound is contained in the bonding layer 16.

Finally, in yet another alternative embodiment of the data storage media 10 of FIG. 5, the heat modulating compound and the heat responsive compound will be present in the read through substrate layer 12. Alternatively, in an additional embodiment, the heat modulating compound and the heat responsive compound will be present in the bonding layer 16.

Finally, the heat responsive compound may also be isolated between a dielectric layer such as polymethylmethacrylate (PMMA) and a substrate layer comprised of polycarbonate. Such a configuration is believed to be advantageous in that the temperature T2 is maintained and prevented from more rapid loss due to direct contact with any metal containing layers.

### PROPHETIC/SIMULATED EXAMPLE 1

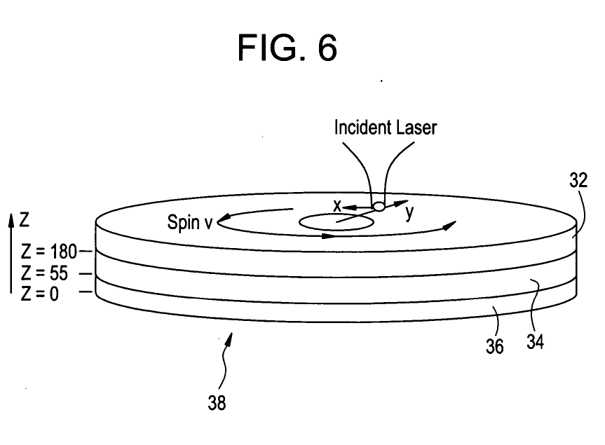

A computer simulation based on a theoretical data storage media was conducted. The theoretical or prophetic data storage media 38 would be comprised of three layers as illustrated in FIG. 6. The uppermost layer 32 will be comprised of polycarbonate; while middle layer 34 will be made of a heat responsive compound and lowermost layer 36 will be comprised of aluminum. The thickness of the layers 32, 34, and 36 is theoretically respectively 0.6 mm, 125 nm, and 55 nm.

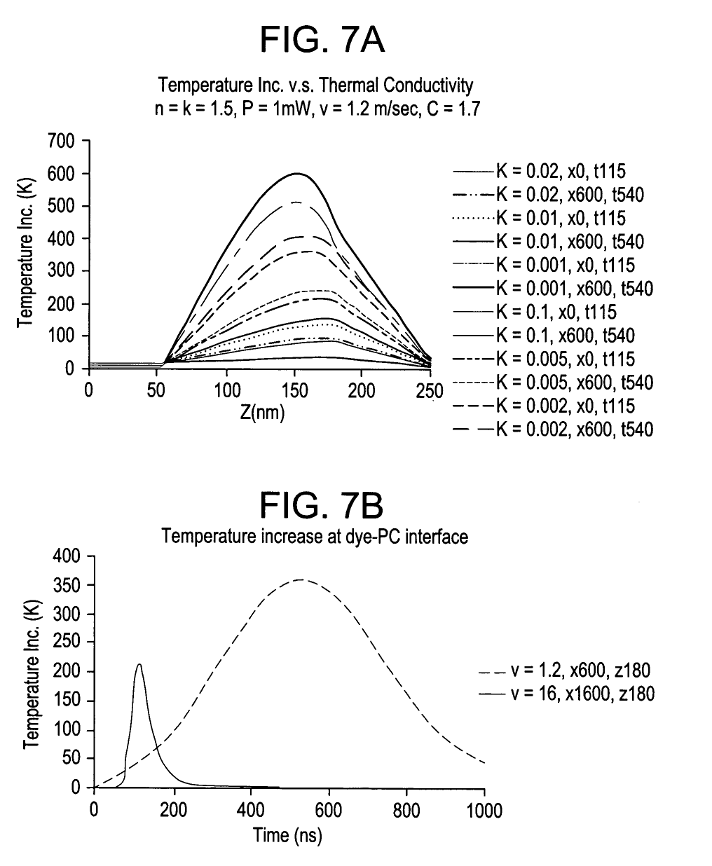

Computer simulations produced FIGS. 7A and 7B that graphically illustrate the expected temperature increase at various simulated conditions. The experimental conditions for the computer simulation were as follows: P is laser power incident on the disc, P=1 mW; −v=disc spin line speed; −n=dye index of refraction; −k=dye extinction coefficient; −C=dye specific heat; −K=dye thermal conductivity constant; −Z=depth (0=edge of A1); −x=linear distance from laser pulse starting pt; and −y=radial direction (orthogonal to x). The laser wavelength: λ=650 nm.

FIG. 7a illustrates the temperature increase as a function of simulated distance away from the metal reflector. FIG. 7b illustrates the temperature increase as a function of time at two different simulated disk spinning speeds, (i.e., 600 rpm and 1600 rpm.).

It should be understood that the magnitude of the temperature increase and the dynamics of the temperature increase, that is, the time at which T changes from T1 to T2 and the duration of T2 may be tailored by the construction of the data storage media, the composition and placement of the various layers, and the composition of the heat sensitive and heat modulating compounds. For example, the onset of the temperature increase shown in FIG. 7 may be delayed by reducing the heat conductivity of the reflective layer, placing a heat management (insulation) layer between the reflective layer and the layer containing the heat modulating compound, or by incorporating the heat modulating compound in the read through substrate or in a layer on the laser incident surface of the read through substrate rather than in a layer adjacent to the reflective layer as presently shown in FIG. 6.

The methods and articles disclosed herein provide a method of authenticating useful in the authentication and confirmation of the source, and identify polymer-based substrates, especially polycarbonate based materials and of articles made from such substrates.

The presence of heat responsive compounds and optionally heat modulating compounds in a particular substrate or data storage media provides for a variety of options with respect to a particularly selected authentication signal for an authenticatable polymer. As a result, counterfeiters and illegitimate producers and sellers will find it more difficult to ‘mimic’ the authentication signal for an authenticatable polymer and articles legitimately made therefrom. Moreover, in some embodiments, the heat responsive compounds will be difficult to detect with UV-Visible spectroscopy since their absorption is generally hidden behind the absorption of the material comprising the article. By using a heat responsive compound whose signals vary with temperature, counterfeiters and illegitimate producers and sellers may be more readily identified and apprehended. The difficulty of predicting the particularly selected signature of a particular heat responsive compound is advantageous in providing an authentication method that thwarts unauthorized duplication and copying activities. In one embodiment, different signatures may be selected for different customers or production batches, even though the same heat responsive compound may be used in all cases. For example, a manufacturer of polycarbonate could produce a single type of polycarbonate that could be used by several different data storage media manufacturers but which would still provide each manufacturer with a “unique” method of authentication.

### EXAMPLE 1

A heat stable organic fluorophore (Lumogen F Red 300, BASF, Germany) was selected for experiments illustrating the effect of heat upon the fluorescence of an actual sample disk prepared according to the instant disclosures. This particular fluorophore has a maximum absorption located at about 578 nm, a fluorescence emission located at about 615 nm and a fluorescence yield greater than 90%. In order to incorporate this fluorophore at a tracer level (about 1 ppm in the final article), it was first compounded into polycarbonate to form a masterbatch with a fluorophore content of 0.005 pph (Lumogen F-300 MB). The thermochromic material was selected to be chemically stable in polycarbonate and able to sustain the processing conditions of this engineering polymer. For this example, a regio-random poly(3-octadecylthiophene) was selected (P3ODT lot #YW1202, available from the University of Rhode Island, Kingston, R.I., USA). This thermochromic material is red at room temperature and turns into a red-shade yellow above the thermochromic transition. Although this material is said to exhibit a thermochromic transition at 65° C., practical experiments have demonstrated that P3DOT requires practically a temperature of about 100° C. (surface temperature of the heater) to undergo a rapid thermochromic change.

The tag combinations were incorporated into optical quality (OQ) polycarbonate formulations via compounding on a twin-screw extruder. The OQ polycarbonate resin formulations used contain a polycarbonate resin with an average molecular weight number Mw of about 17,700 (measured using Gel Permeation Chromatography against absolute polycarbonate standards), a phosphite heat stabilizer and a mold release agent. Plaque samples (thickness 0.60 and 1.20 mm) from the various formulations were subsequently obtained by injection molding of the pellets formed after the extrusion step. The tag concentrations for the various samples are presented in Table 1.

TABLE 1
Sample composition (in pph).

| Composition | MWB0703031-2 | MWB0703031-3 | MWB0703031-4 | MWB0703031-5 |
|---|---|---|---|---|
| OQ PC resin | 100 | 100 | 100 | 100 |
| Heat stabilizer | 0.02 | 0.02 | 0.02 | 0.02 |
| Mold release | 0.03 | 0.03 | 0.03 | 0.03 |
| Lumogen ⁽™⁾ F-300 MB | | 2 | 2 | 2 |
| P3DOT | 0.05 | | 0.05 | 0.05 |
| NIR absorber | | | | 0.0017 |

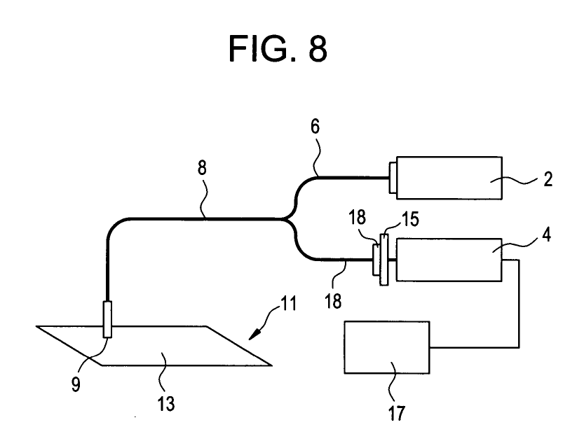

An experimental setup for analysis of polymeric articles is shown in FIG. 8. Fluorescence measurements of polymeric articles were performed using a miniature 532-nm laser (Nanolase, France) as the heat source 2 and a portable spectrofluorometer 4. The spectrofluorometer 4 (Ocean Optics, Inc., Dunedin, Fla., Model ST2000) was equipped with a 200-μm slit, 600-grooves/mm grating blazed at 400 nm and covering the spectral range from 250 to 800 nm with efficiency greater than 30%, and a linear CCD-array detector. Light from the laser 2 was focused into a first optical arm 6, one of two arms of a “six-around-one” bifurcated fiber-optic reflection probe 8 (Ocean Optics, Inc., Model R400-7-UV/VIS). Emission light from the sample 10 was collected when the common end 8 of the fiber-optic probe 8 was positioned near the sample 10 at a 0 or 45 angle to the normal to the surface 12. The second optical fiber arm 12 of the probe 8 was coupled to the spectrometer 4. In some experiments, excitation light was blocked from entering the spectrometer 4 with a long-pass optical filter 14. Processing of collected spectra was performed using KaleidaGraph (Synergy Software, Reading, Pa.) on a computer 16.

Heating of the polymeric articles was performed using a built-in-house heater or a heat gun.

### EXAMPLE 2

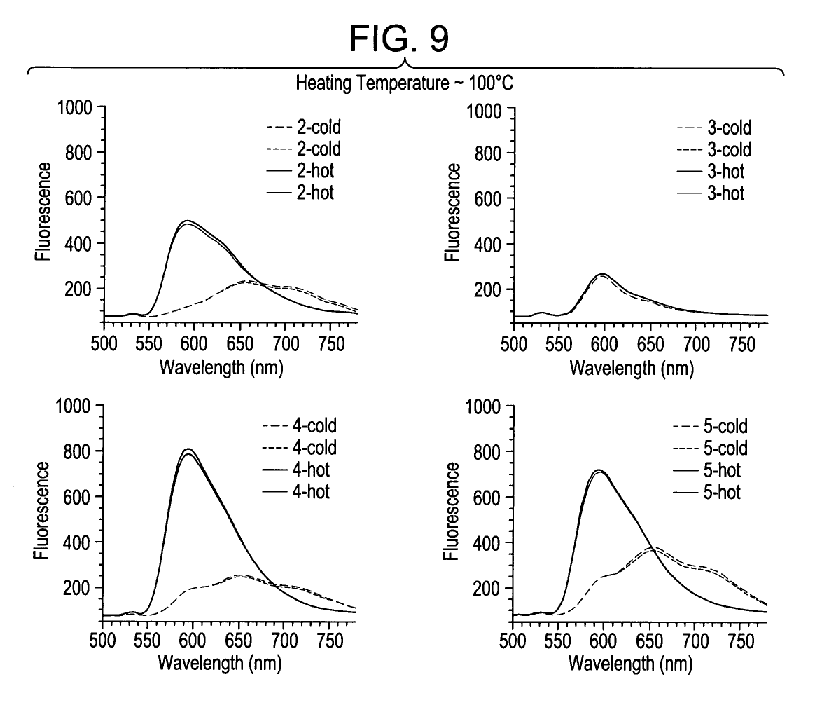

FIG. 9 depicts the differences between fluorescence spectra of polymeric articles prepared in Example 1 and measured when the articles were at room temperature (cold) and at 100° C. (hot) as per the experimental set up of FIG. 8. FIG. 9 shows the fluorescence emission profile of samples MWB0703031-2 to -5 at an excitation wavelength of 532 nm at room temperature (cold) and when heated at about 100° C. (hot). Sample MWB0703031-2, which contains only the thermochromic tag (0.05 pph of P3ODT), shows a significant change in its fluorescence spectrum when the sample temperature is raised to about 100° C. The fluorescence emission is not only increased but the peak location shifts from about 650 nm to about 590 nm. Sample MWB0703031-3, which contains only an organic fluorophore (1 ppm of BASF Lumogen F-300) shows no change in its fluorescence emission characteristics between “cold” and “hot” state. In comparison, when the same organic fluorophone is added as an amplification compound in combination with the thermochromic compound (case of samples MWB0703031-4 and MWB0703031-5) the fluorescence emission spectrum changes significantly between the first temperature and the authentication temperature, i.e., the cold and hot states. The emission in the “hot” state at the authentication temperature exhibits a more defined peak (i.e. more intense and less broad) with a maximum at about 590 nm compared to sample MWB0703031-2 (thermochromic compound alone). This illustrates the synergistic effect between the fluorophore and the thermochromic compound. Note that the fact that the difference in fluorescence emission during the identification process is largely unaffected by the presence of the NIR absorber is significant. As a result, the NIR absorber and more specifically its absorption characteristics can be used to create an internal heat pulse induced by an external NIR light source such as a laser.

### EXAMPLE 3

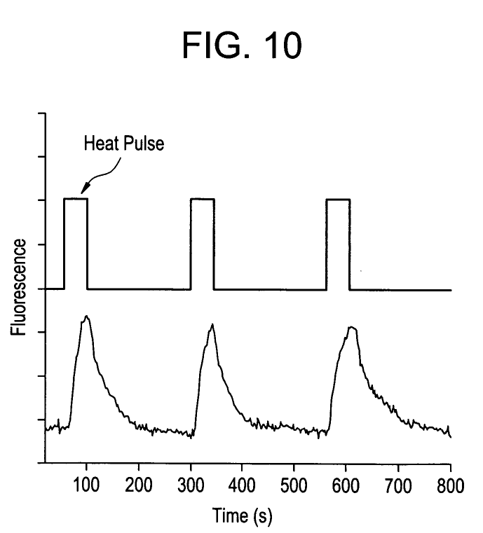

FIG. 10 demonstrates the reversibility of the fluorescence intensity increase upon heating of material MWB070703 1-4 as prepared in Example 1. Sample MWB070303 1-4 was exposed to consecutive short heat pulses from a heat gun while dynamic fluorescence measurements were taken.

This example illustrates that the disclosed methods provide a more robust identification method that can be performed many times. This feature is of particular interest in anti-piracy where articles could be checked at various stages during production, shipping, and distribution or even in court to prove or disprove the authenticity of a product.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for authenticating that an article is an authenticatable article using an optical tester, the optical tester comprising an electromagnetic radiation source and a detector, and the authenticatable article comprising a heat responsive compound having a temperature dependent optical interaction with the electromagnetic radiation source in the presence of a heat stimulus to produce a heat induced electromagnetic radiation signature, the method comprising
placing a test portion of the article in interaction with the electromagnetic radiation source of the optical tester
creating a heated portion by exposing the test portion of the article to a heat stimulus sufficient to raise the temperature of the test portion from a temperature T1 to a temperature T2,
measuring the heat induced electromagnetic radiation signature of the heated portion with the detector, and
authenticating that the article is an authenticatable article if the heat induced electromagnetic radiation signature is present.

2. The method of claim 1 wherein the optical tester is a data storage media player.

3. The method of claim 1 wherein the electromagnetic radiation source is a laser.

4. The method of claim 3 wherein the electromagnetic radiation source is a laser having a wavelength of about 750 nm to 810 nm.

5. The method of claim 3 wherein the electromagnetic radiation source is a laser having a wavelength of about 600 nm to 680 nm.

6. The method of claim 3 wherein the electromagnetic radiation source is a laser having a wavelength of about 370 nm to 450 nm.

7. The method of claim 1 wherein the detector is a photodetector.

8. The method of claim 1 wherein the heat responsive compound has a first optical interaction with the electromagnetic radiation source at a temperature T1 and a second optical interaction with the electromagnetic radiation source at a temperature T2.

9. The method of claim 1 wherein the authenticatable article further comprises a heat modulator.

10. The method of claim 1 wherein the heat stimulus is applied externally to the article.

11. The method of claim 1 wherein the heat stimulus comes from the optical tester.

12. The method of claim 9 wherein the heat modulator absorbs electromagnetic radiation and converts it to thermal energy.

13. The method of claim 12 wherein the heat modulator is at least one of an NIR absorber, a colorant, a UV absorber, inorganic nanoparticles, and combinations of such heat modulating compounds.

14. The method of claim 12 wherein the heat stimulus originates from the interaction of the heat modulator and the electromagnetic radiation source.

15. The method of claim 13 wherein the authenticatable article is an authenticatable data storage media.

16. The method of claim 15 wherein the authenticatable data storage media comprises a read through substrate layer and a reflective layer.

17. The method of claim 16 wherein the authenticatable data storage media further comprises one or more additional substrate layers.

18. The method of claim 17 wherein the authenticatable data storage media further comprises a bonding layer.

19. The method of claim 17 wherein the authenticatable data storage media further comprises a semi-reflective layer.

20. The method of claim 16 wherein the authenticatable data storage media further comprises a heat modulator.

21. The method of claim 20 wherein the heat modulator is located on a surface of the read through substrate layer.

22. The method of claim 20 wherein the heat modulator is in the read through substrate layer.

23. The method of claim 22 wherein the read through substrate layer is comprised of polycarbonate.

24. The method of claim 18 wherein the heat modulator is in the bonding layer.

25. The method of claim 16 wherein the heat responsive compound is located on a surface of the read through substrate layer.

26. The method of claim 16 wherein the heat responsive compound is in the read through substrate layer.

27. The method of claim 26 wherein the read through substrate layer is comprised of polycarbonate.

28. The method of claim 18 wherein the heat responsive compound is in the bonding layer.

29. The method of claim 18 wherein the heat responsive compound and the heat modulator are in the bonding layer.

30. The method of claim 20 wherein the heat responsive compound and the heat modulator are in the read through substrate layer.

31. The method of claim 18 wherein the heat responsive compound and the heat modulator are on the read through substrate layer.

32. The method of claim 1 wherein the heat responsive compound is one of temperature-sensitive inorganic materials, temperature-sensitive organic materials, and combinations of such heat responsive compounds.

33. The method of claim 32 wherein the heat responsive compound is a temperature-sensitive inorganic material that is at least one of phosphor, semiconductor quantum dots, anti-stokes shift luminescent compounds, stokes shift luminescent compounds, inorganic salts, and combinations of such temperature-sensitive inorganic materials.

34. The method of claim 32 wherein the heat responsive compound is a temperature-sensitive organic material that is at least one of organic absorbing dyes, organic fluorescent dyes, liquid crystal materials, thermochromic compounds, organic salts, temperature sensitive encapsulated dyes, leuco dyes protected with a thermally labile group, and combinations of such temperature-sensitive organic materials.

35. The method of claim 1 wherein the heat responsive compound is at least one of temperature dependent phase separable polymers, polymers having a coefficient of thermal expansion greater than about 0.1 mm per ° C., and combinations of such heat responsive compounds.

36. The method of claim 1 wherein the heat responsive compound is at least one compound selected from the group consisting of thermochromic compounds, temperature sensitive scattering compounds, compounds having a temperature sensitive refractive index change, compounds having a temperature sensitive dimensional stability, temperature sensitive photo luminescent compounds, temperature sensitive encapsulated dyes, leuco dyes protected with a thermally labile group and combinations thereof.

37. The method of claim 1 wherein the heat induced electromagnetic radiation signature is at least one of reflected electromagnetic radiation, transmitted electromagnetic radiation, emitted electromagnetic radiation and combinations of such heat induced electromagnetic radiation signatures.

38. The method of claim 1 wherein the heat induced electromagnetic radiation signature that is measured by the detector is at least one of intensity, spectral distribution, ratio of intensity, peak position, and combinations thereof.

39. The method of claim 38 wherein the heat induced electromagnetic radiation signature is reflected electromagnetic radiation.

40. The method of claim 38 wherein the heat induced electromagnetic radiation signature is transmitted electromagnetic radiation.

41. The method of claim 38 wherein the heat induced electromagnetic radiation signature is emitted electromagnetic radiation.

42. The method of claim 37 wherein the heat induced electromagnetic radiation signature is a percentage of the electromagnetic radiation emitted by the electromagnetic radiation source of the optical tester reflected by the test portion at a wavelength of the electromagnetic radiation source.

43. The method of claim 1 wherein the temperature dependent optical interaction is at least one of absorption, reflection, scattering, luminescence.

44. The method of claim 1 wherein the heating of the test portion creates a heated portion having a change in at least one of the following material properties consisting of electronic absorption, refractive index, birefringence, dimensional stability, luminescence, and combinations thereof.

45. The method of claim 1 wherein T1 is a temperature of about 5 to about 55 degrees C.

46. The method of claim 1 wherein T2 is a temperature of about 35 to about 235 degrees C.

47. The method of claim 1 wherein T1 is a temperature of about 5 to about 55 degrees C. and T2 is a temperature of about 35 to about 235 degrees C.

48. The method of claim 47 wherein T1 is a temperature of about 10 to about 40 degrees C. and T2 is a temperature of about 45 to about 145 degrees C.

49. The method of claim 1 further comprising the step of inserting the article into the optical tester.

50. The method of claim 1 further comprising measuring the heat induced electromagnetic radiation signature originating from the interaction of the electromagnetic radiation source with the test portion at temperature T1.

51. The method of claim 50 further comprising measuring the heat induced electromagnetic radiation signature originating from the interaction of the electromagnetic radiation source with the test portion at temperature T2.

52. The method of claim 1 wherein the article is spinning during the authentication at a rate R between 1 rpm and 40,000 rpm.

53. The method of claim 52 wherein the heat induced electromagnetic radiation signature is measured at a rate R2 that is different from the normal spinning rate of the article R1.

54. The method of claim 53 wherein R1 is smaller than R2.

55. The method of claim 53 wherein R1 is greater than R2.

56. The method of claim 1 wherein the authentication of the authenticatable article can be performed only once.

57. The method of claim 1 wherein the authentication of the authenticatable article can be performed more than once.

58. The method of claim 1 wherein the difference between temperature T2 and temperature T1 is between about 5 to about 200 degrees C.

59. The method of claim 58 wherein the difference between temperature T2 and temperature T1 is between about 5 to about 100 degrees C.

60. An authenticatable polymer comprising
a heat responsive compound having a temperature dependent optical interaction with an electromagnetic radiation source in the presence of a heat stimulus to produce a heat induced electromagnetic radiation signature, and
a heat modulator that absorbs electromagnetic radiation and converts it to thermal energy.

61. The authenticatable polymer of claim 60 that is a substrate polymer.

62. The authenticatable polymer of claim 60 that is a bonding adhesive.

63. The authenticatable polymer of claim 60 that is a coating on a surface of the read through substrate.

64. The authenticatable polymer of claim 60 wherein the heat responsive compound is at least one of the group consisting of temperature-sensitive inorganic materials, temperature-sensitive organic materials, and combinations of such heat responsive compounds and the heat modulator is at least one of the group consisting of a NIR absorber, a colorant, a UV absorber, inorganic nanoparticles, and combinations of such heat modulating compounds.

65. The authenticatable polymer of claim 64 wherein the heat responsive compound is a temperature-sensitive inorganic material that is at least one of phosphor, semiconductor quantum dots, anti-stokes shift luminescent compounds, stokes shift luminescent compounds, inorganic salts, and combinations of such temperature-sensitive inorganic materials.

66. The authenticatable polymer of claim 64 wherein the heat responsive compound is a temperature-sensitive organic material that is at least one of organic absorbing dyes, organic fluorescent dyes, liquid crystal materials, thermochromic compounds, organic salts, temperature sensitive encapsulated dyes, leuco dyes protected with a thermally labile group, and combinations of such temperature-sensitive organic materials.

67. The authenticatable polymer of claim 64 wherein the heat responsive compound is at least one of temperature dependent phase separable polymers, polymers having a coefficient of thermal expansion greater than about 0.1 mm per ° C., and combinations of such heat responsive compounds.

68. The authenticatable polymer of claim 64 wherein the heat responsive compound is at least one compound selected from the group consisting of thermochromic compounds, temperature sensitive scattering compounds, compounds having a temperature sensitive refractive index change, compounds having a temperature sensitive dimensional stability, temperature sensitive photo luminescent compounds, leuco dyes protected with a thermally labile group and combinations thereof.

69. An article comprised of the authenticatable polymer of claim 60.

70. The article of claim 69 that is a data storage media.

71. The data storage media of claim 70 comprising a read through substrate layer and a reflective layer.

72. The data storage media of 71 wherein the read through substrate layer comprises the authenticatable polymer.

73. The data storage media of claim 71 comprising one or more additional substrate layers.

74. The data storage media of claim 73 further comprising a bonding layer.

75. The data storage media of claim 74 wherein the bonding layer comprises the authenticatable polymer.
